(19) United States
(12) Patent Application Publication
(10) Pub. No.: US 2025/0062809 A1
(43) Pub. Date: Feb. 20, 2025

(54) REPORTING OF MEASURED AND PREDICTION BASED BEAM MANAGEMENT

(71) Applicant: QUALCOMM Incorporated, San Diego, CA (US)

(72) Inventors: Qiaoyu LI, Beijing (CN); Arumugam CHENDAMARAI KANNAN, San Diego, CA (US); Mahmoud TAHERZADEH BOROUJENI, San Diego, CA (US); Tao LUO, San Diego, CA (US)

(21) Appl. No.: 18/719,317

(22) PCT Filed: Feb. 18, 2022
(86) PCT No.: PCT/CN2022/076811

§ 371 Date: Jun. 13, 2024

(51) Int. Cl. H04B 7/06; H04B 7/0456; H04B 17/318

(52) U.S. Cl. CPC H04B 7/0626; H04B 7/0456; H04B 17/328

(57) ABSTRACT

Wireless communications systems and methods related to communicating control information are provided. A method of wireless communication performed by a user equipment (UE) may include receiving, from a base station (BS), a configuration for a channel state information (CSI) report setting, wherein a report quantity configured by the CSI report setting comprises at least measured channel characteristics of channel state information reference signal (CSI-RS) resources or synchronization signal block (SSB) resources for channel measurement associated with the CSI report setting and parameters of predicted channel characteristics associated with the CSI-RS resources or the SSB resources for channel measurement associated with the CSI report setting and transmitting, to the BS, a CSI report based on the CSI report setting.

### TECHNICAL FIELD

This application relates to wireless communication systems, and more particularly, to reporting of measured and prediction based beam management.

### INTRODUCTION

Wireless communications systems are widely deployed to provide various types of communication content such as voice, video, packet data, messaging, broadcast, and so on. These systems may be capable of supporting communication with multiple users by sharing the available system resources (e.g., time, frequency, and power). A wireless multiple-access communications system may include a number of base stations (BSs), each simultaneously supporting communications for multiple communication devices, which may be otherwise known as user equipment (UE).

To meet the growing demands for expanded mobile broadband connectivity, wireless communication technologies are advancing from the LTE technology to a next generation new radio (NR) technology. For example, NR is designed to provide a lower latency, a higher bandwidth or throughput, and a higher reliability than LTE. NR is designed to operate over a wide array of spectrum bands, for example, from low-frequency bands below about 1 gigahertz (GHz) and mid-frequency bands from about 1 GHz to about 6 GHZ, to high-frequency bands such as millimeter wave (mmWave) bands. NR is also designed to operate across different spectrum types, from licensed spectrum to unlicensed and shared spectrum. Spectrum sharing enables operators to opportunistically aggregate spectrums to dynamically support high-bandwidth services. Spectrum sharing can extend the benefit of NR technologies to operating entities that may not have access to a licensed spectrum.

NR may support various deployment scenarios to benefit from the various spectrums in different frequency ranges, licensed and/or unlicensed, and/or coexistence of the LTE and NR technologies. For example, NR can be deployed in a standalone NR mode over a licensed and/or an unlicensed band or in a dual connectivity mode with various combinations of NR and LTE over licensed and/or unlicensed bands.

In a wireless communications system, a BS may communicate with a UE in an uplink direction and a downlink direction. Sidelink was introduced in LTE to allow a UE to send data to another UE (e.g., from one vehicle to another vehicle) without tunneling through the BS and/or an associated core network. The LTE sidelink technology has been extended to provision for device-to-device (D2D) communications, vehicle-to-everything (V2X) communications, and/or cellular vehicle-to-everything (C-V2X) communications. Similarly, NR may be extended to support sidelink communications, D2D communications, V2X communications, and/or C-V2X over licensed frequency bands and/or unlicensed frequency bands (e.g., shared frequency bands).

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In an aspect of the disclosure, a method of wireless communication performed by a user equipment (UE) may include receiving, from a base station (BS), a configuration for a channel state information (CSI) report setting, wherein a report quantity configured by the CSI report setting comprises at least measured channel characteristics of channel state information reference signal (CSI-RS) resources or synchronization signal block (SSB) resources for channel measurement associated with the CSI report setting and parameters of predicted channel characteristics associated with the CSI-RS resources or the SSB resources for channel measurement associated with the CSI report setting; and transmitting, to the BS, a CSI report based on the CSI report setting.

In an additional aspect of the disclosure, a method of wireless communication may include transmitting a configuration for a channel state information (CSI) report setting, wherein a report quantity configured by the CSI report setting comprises at least measured channel characteristics of channel state information reference signal (CSI-RS) resources or synchronization signal block (SSB) resources for channel measurement associated with the CSI report setting and parameters of predicted channel characteristics associated with the CSI-RS resources or the SSB resources for channel measurement associated with the CSI report setting; and receiving a CSI report based on the CSI report setting.

In an additional aspect of the disclosure, a user equipment (UE) may include a processor; memory coupled with the processor; and instructions stored in the memory and executable by the processor to cause the UE to receive, from a base station (BS), a configuration for a channel state information (CSI) report setting, wherein a report quantity configured by the CSI report setting comprises at least measured channel characteristics of channel state information reference signal (CSI-RS) resources or synchronization signal block (SSB) resources for channel measurement associated with the CSI report setting and parameters of predicted channel characteristics associated with the CSI-RS resources or the SSB resources for channel measurement associated with the CSI report setting; and transmit, to the BS, a CSI report based on the CSI report setting.

In an additional aspect of the disclosure, an apparatus for wireless communications may include a processor; memory coupled with the processor; and instructions stored in the memory and executable by the processor to cause the apparatus to transmit a configuration for a channel state information (CSI) report setting, wherein a report quantity configured by the CSI report setting comprises at least measured channel characteristics of channel state information reference signal (CSI-RS) resources or synchronization signal block (SSB) resources for channel measurement associated with the CSI report setting and parameters of predicted channel characteristics associated with the CSI-RS resources or the SSB resources for channel measurement associated with the CSI report setting; and receive a CSI report based on the CSI report setting.

Other aspects, features, and instances of the present invention will become apparent to those of ordinary skill in the art, upon reviewing the following description of specific, exemplary instances of the present invention in conjunction with the accompanying figures. While features of the present invention may be discussed relative to certain aspects and figures below, all instances of the present invention can include one or more of the advantageous features discussed herein. In other words, while one or more instances may be discussed as having certain advantageous features, one or more of such features may also be used in accordance with the various instances of the invention discussed herein. In similar fashion, while exemplary aspects may be discussed below as device, system, or method instances it should be understood that such exemplary instances can be implemented in various devices, systems, and methods.

### BRIEF DESCRIPTION OF THE DRAWINGS

FIG. 1 illustrates a wireless communication network according to some aspects of the present disclosure.

FIG. 2A illustrates wireless communication network according to some aspects of the present disclosure

FIG. 2B illustrates a wireless communication network according to some aspects of the present disclosure.

FIG. 3 illustrates CSI reporting periods according to some aspects of the present disclosure.

FIG. 4 illustrates beams associated with a wireless communications network according to some aspects of the present disclosure.

FIG. 5A illustrates a CSI report payload structure according to some aspects of the present disclosure.

FIG. 5B illustrates a CSI report payload structure according to some aspects of the present disclosure.

FIG. 6 is a signaling diagram of a wireless communication method according to some aspects of the present disclosure.

FIG. 7 is a signaling diagram of a wireless communication method according to some aspects of the present disclosure.

FIG. 8 is a block diagram of an exemplary user equipment (UE) according to some aspects of the present disclosure.

FIG. 9 is a block diagram of an exemplary base station (BS) according to some aspects of the present disclosure.

FIG. 10 illustrates a wireless communication network according to some aspects of the present disclosure.

FIG. 11 is a flow diagram of a communication method according to some aspects of the present disclosure.

FIG. 12 is a flow diagram of a communication method according to some aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

This disclosure relates generally to wireless communications systems, also referred to as wireless communications networks. In various instances, the techniques and apparatus may be used for wireless communications systems such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5th Generation (5G) or new radio (NR) networks, as well as other communications networks. As described herein, the terms “networks” and “systems” may be used interchangeably.

An OFDMA network may implement a radio technology such as evolved UTRA (E-UTRA), Institute of Electrical and Electronic Engineers (IEEE) 802.11, IEEE 802.16, IEEE 802.20, flash-OFDM and the like. UTRA, E-UTRA, and Global System for Mobile Communications (GSM) are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3rd Generation Partnership Project (3GPP) is a collaboration between groups of telecommunications associations that aims to define a globally applicable third generation (3G) mobile phone specification. 3GPP long term evolution (LTE) is a 3GPP project which was aimed at improving the universal mobile telecommunications system (UMTS) mobile phone standard. The 3GPP may define specifications for the next generation of mobile networks, mobile systems, and mobile devices. The present disclosure is concerned with the evolution of wireless technologies from LTE, 4G, 5G, NR, and beyond with shared access to wireless spectrum between networks using a collection of new and different radio access technologies or radio air interfaces.

In particular, 5G networks contemplate diverse deployments, diverse spectrum, and diverse services and devices that may be implemented using an OFDM-based unified, air interface. In order to achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., ^{˜}1M nodes/km²), ultra-low complexity (e.g., ^{˜}10 s of bits/sec), ultra-low energy (e.g., ^{˜}10+ years of battery life), and deep coverage with the capability to reach challenging locations; (2) including mission-critical control with strong security to safeguard sensitive personal, financial, or classified information, ultra-high reliability (e.g., ^{˜}99.9999% reliability), ultra-low latency (e.g., ^{˜}1 ms), and users with wide ranges of mobility or lack thereof; and (3) with enhanced mobile broadband including extreme high capacity (e.g., ^{˜}10 Tbps/km²), extreme data rates (e.g., multi-Gbps rate, 100+ Mbps user experienced rates), and deep awareness with advanced discovery and optimizations.

The 5G NR may be implemented to use optimized OFDM-based waveforms with scalable numerology and transmission time interval (TTI); having a common, flexible framework to efficiently multiplex services and features with a dynamic, low-latency time division duplex (TDD)/frequency division duplex (FDD) design; and with advanced wireless technologies, such as massive multiple input, multiple output (MIMO), robust millimeter wave (mmWave) transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD/TDD implementations, subcarrier spacing may occur with 15 kHz, for example over 5, 10, 20 MHz, and the like bandwidth (BW). For other various outdoor and small cell coverage deployments of TDD greater than 3 GHZ, subcarrier spacing may occur with 30 kHz over 80/100 MHz BW. For other various indoor wideband implementations, using a TDD over the unlicensed portion of the 5 GHz band, the subcarrier spacing may occur with 60 kHz over a 160 MHz BW. Finally, for various deployments transmitting with mmWave components at a TDD of 28 GHz, subcarrier spacing may occur with 120 kHz over a 500 MHz BW.

The scalable numerology of the 5G NR facilitates scalable TTI for diverse latency and quality of service (QOS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink/downlink scheduling information, data, and acknowledgement in the same subframe. The self-contained integrated subframe supports communications in unlicensed or contention-based shared spectrum, adaptive uplink/downlink that may be flexibly configured on a per-cell basis to dynamically switch between uplink and downlink to meet the current traffic needs.

Various other aspects and features of the disclosure are further described below. It should be apparent that the teachings herein may be embodied in a wide variety of forms and that any specific structure, function, or both being disclosed herein is merely representative and not limiting. Based on the teachings herein one of an ordinary level of skill in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. For example, a method may be implemented as part of a system, device, apparatus, and/or as instructions stored on a computer readable medium for execution on a processor or computer. Furthermore, an aspect may comprise at least one element of a claim.

The deployment of NR over an unlicensed spectrum is referred to as NR-unlicensed (NR-U). Federal Communications Commission (FCC) and European Telecommunications Standards Institute (ETSI) are working on regulating 6 GHz as a new unlicensed band for wireless communications. The addition of 6 GHz bands allows for hundreds of megahertz (MHz) of bandwidth (BW) available for unlicensed band communications. Additionally, NR-U can also be deployed over 2.4 GHz unlicensed bands, which are currently shared by various radio access technologies (RATs), such as IEEE 802.11 wireless local area network (WLAN) or WiFi and/or license assisted access (LAA). Sidelink communications may benefit from utilizing the additional bandwidth available in an unlicensed spectrum. However, channel access in a certain unlicensed spectrum may be regulated by authorities. For instance, some unlicensed bands may impose restrictions on the power spectral density (PSD) and/or minimum occupied channel bandwidth (OCB) for transmissions in the unlicensed bands. For example, the unlicensed national information infrastructure (UNII) radio band has a minimum OCB requirement of about 70 percent (%).

Some sidelink systems may operate over a 20 MHz bandwidth in an unlicensed band. A BS may configure a sidelink resource pool over the 20 MHz band for sidelink communications. A sidelink resource pool is typically partitioned into multiple frequency subchannels or frequency subbands (e.g., about 5 MHz each) and a sidelink UE may select a sidelink resource (e.g., a subchannel) from the sidelink resource pool for sidelink communication. To satisfy an OCB of about 70%, a sidelink resource pool may utilize a frequency-interlaced structure. For instance, a frequency-interlaced-based sidelink resource pools may include a plurality of frequency interlaces over the 20 MHz band, where each frequency interlace may include a plurality of resource blocks (RBs) distributed over the 20 MHz band. For example, the plurality of RBs of a frequency interlace may be spaced apart from each other by one or more other RBs in the 20 MHz unlicensed band. A sidelink UE may select a sidelink resource in the form of frequency interlaces from the sidelink resource pool for sidelink communication. In other words, sidelink transmissions may utilize a frequency-interlaced waveform to satisfy an OCB of the unlicensed band. However, S-SSBs may be transmitted in a set of contiguous RBs, for example, in about eleven contiguous RBs. As such, S-SSB transmissions alone may not meet the OCB requirement of the unlicensed band. Accordingly, it may be desirable for a sidelink sync UE to multiplex an S-SSB transmission with one or more channel state information reference signals (CSI-RSs) in a slot configured for S-SSB transmission so that the sidelink sync UE's transmission in the slot may comply with an OCB requirement.

The present application describes mechanisms for a sidelink UE to multiplex an S-SSB transmission with a CSI-RS transmission in a frequency band to satisfy an OCB of the frequency band. For instance, the sidelink UE may determine a multiplex configuration for multiplexing a CSI-RS transmission with an S-SSB transmission in a sidelink BWP. The sidelink UE may transmit the S-SSB transmission in the sidelink BWP during a sidelink slot. The sidelink UE may transmit one or more CSI-RSs in the sidelink BWP during the sidelink slot by multiplexing the CSI-RS and the S-SSB transmission based on the multiplex configuration.

In some aspects, the sidelink UE may transmit the S-SSB transmission at an offset from a lowest frequency of the sidelink BWP based on a synchronization raster (e.g., an NR-U sync raster). In some aspects, the sidelink UE may transmit the S-SSB transmission aligned to a lowest frequency of the sidelink BWP. For instance, a sync raster can be defined for sidelink such that the S-SSB transmission may be aligned to a lowest frequency of the sidelink BWP.

In some aspects, the multiplex configuration includes a configuration for multiplexing the S-SSB transmission with a frequency interlaced waveform sidelink transmission to meet the OCB requirement. For instance, the sidelink transmission may include a CSI-RS transmission multiplexed in frequency within a frequency interlace with RBs spaced apart in the sidelink BWP. In some instances, the sidelink UE may rate-match the CSI-RS transmission around RBs that are at least partially overlapping with the S-SSB transmission.

In some aspects, the multiplex configuration includes a configuration for multiplexing the S-SSB transmission with a subchannel-based sidelink transmission to meet the OCB requirement. For instance, the sidelink transmission may include a CSI-RS transmission multiplexed in time within a subchannel including contiguous RBs in the sidelink BWP. For instance, the S-SSB transmission may be transmitted at a low frequency portion of the sidelink BWP, and the CSI-RS may be transmitted in a subchannel located at a high frequency portion of the sidelink BWP to meet the OCB.

In some aspects, a BS may configure different sidelink resource pools for slots that are associated with S-SSB transmissions and for slots that are not associated with S-SSB transmissions. For instance, the BS may configure a first resource pool with a frequency-interlaced structure for slots that are not configured for S-SSB transmissions. The first resource pool may include a plurality of frequency interlaces (e.g., distributed RBs), where each frequency interlace may carry a PSCCH/PSSCH transmission. The BS may configure a second resource pool with a subchannel-based structure for slots that are configured for S-SSB transmission. The second resource pool may include a plurality of frequency subchannels (e.g., contiguous RBs), where each subchannel may carry a PSCCH/PSSCH transmission. To satisfy an OCB in a sidelink slot configured for an S-SSB transmission, the sidelink UE (e.g., a sidelink sync UE) may transmit an S-SSB transmission multiplexed with a CSI-RS transmission. For instance, the S-SSB transmission may be transmitted in frequency resources located at a lower frequency portion of a sidelink BWP and the CSI-RS transmission may be transmitted in frequency resources located at higher frequency portion of the sidelink BWP.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

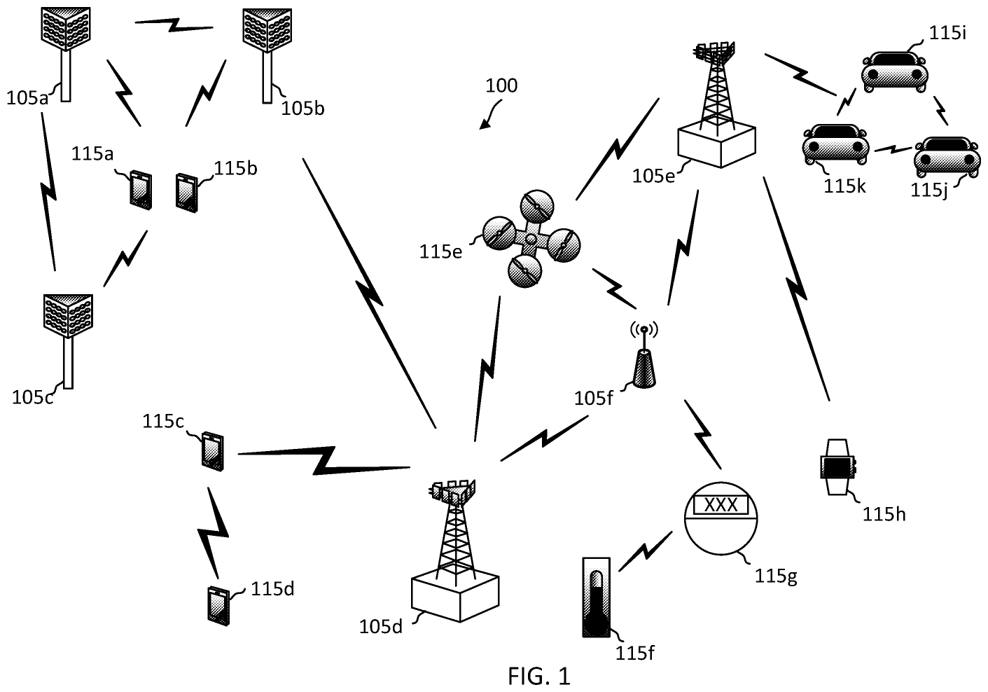

FIG. 1 illustrates a wireless communication network 100 according to some aspects of the present disclosure. The network 100 includes a number of base stations (BSs) 105 and other network entities. A BS 105 may be a station that communicates with UEs 115 and may also be referred to as an evolved node B (eNB), a next generation eNB (gNB), an access point, and the like. Each BS 105 may provide communication coverage for a particular geographic area. In 3GPP, the term “cell” can refer to this particular geographic coverage area of a BS 105 and/or a BS subsystem serving the coverage area, depending on the context in which the term is used.

A BS 105 may provide communication coverage for a macro cell or a small cell, such as a pico cell or a femto cell, and/or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A BS for a macro cell may be referred to as a macro BS. A BS for a small cell may be referred to as a small cell BS, a pico BS, a femto BS or a home BS. In the example shown in FIG. 1, the BSs 105d and 105e may be regular macro BSs, while the BSs 105a-105c may be macro BSs enabled with one of three dimension (3D), full dimension (FD), or massive MIMO. The BSs 105a-105c may take advantage of their higher dimension MIMO capabilities to exploit 3D beamforming in both elevation and azimuth beamforming to increase coverage and capacity. The BS 105f may be a small cell BS which may be a home node or portable access point. A BS 105 may support one or multiple (e.g., two, three, four, and the like) cells.

The network 100 may support synchronous or asynchronous operation. For synchronous operation, the BSs may have similar frame timing, and transmissions from different BSs may be approximately aligned in time. For asynchronous operation, the BSs may have different frame timing, and transmissions from different BSs may not be aligned in time.

The UEs 115 are dispersed throughout the wireless network 100, and each UE 115 may be stationary or mobile. A UE 115 may also be referred to as a terminal, a mobile station, a subscriber unit, a station, or the like. A UE 115 may be a cellular phone, a personal digital assistant (PDA), a wireless modem, a wireless communication device, a handheld device, a tablet computer, a laptop computer, a cordless phone, a wireless local loop (WLL) station, or the like. In one aspect, a UE 115 may be a device that includes a Universal Integrated Circuit Card (UICC). In another aspect, a UE may be a device that does not include a UICC. In some aspects, the UEs 115 that do not include UICCs may also be referred to as IoT devices or internet of everything (IoE) devices. The UEs 115a-115d are examples of mobile smart phone-type devices accessing network 100. A UE 115 may also be a machine specifically configured for connected communication, including machine type communication (MTC), enhanced MTC (eMTC), narrowband IoT (NB-IoT) and the like. The UEs 115e-115h are examples of various machines configured for communication that access the network 100. The UEs 115i-115k are examples of vehicles equipped with wireless communication devices configured for communication that access the network 100. A UE 115 may be able to communicate with any type of the BSs, whether macro BS, small cell, or the like. In FIG. 1, a lightning bolt (e.g., communication links) indicates wireless transmissions between a UE 115 and a serving BS 105, which is a BS designated to serve the UE 115 on the downlink (DL) and/or uplink (UL), desired transmission between BSs 105, backhaul transmissions between BSs, or sidelink transmissions between UEs 115.

In operation, the BSs 105a-105c may serve the UEs 115a and 115b using 3D beamforming and coordinated spatial techniques, such as coordinated multipoint (COMP) or multi-connectivity. The macro BS 105d may perform backhaul communications with the BSs 105a-105c, as well as small cell, the BS 105f. The macro BS 105d may also transmits multicast services which are subscribed to and received by the UEs 115c and 115d. Such multicast services may include mobile television or stream video, or may include other services for providing community information, such as weather emergencies or alerts, such as Amber alerts or gray alerts.

The BSs 105 may also communicate with a core network. The core network may provide user authentication, access authorization, tracking, Internet Protocol (IP) connectivity, and other access, routing, or mobility functions. At least some of the BSs 105 (e.g., which may be an example of an evolved NodeB (eNB) or an access node controller (ANC)) may interface with the core network 130 through backhaul links (e.g., S1, S2, etc.) and may perform radio configuration and scheduling for communication with the UEs 115. In various examples, the BSs 105 may communicate, either directly or indirectly (e.g., through core network), with each other over backhaul links (e.g., X1, X2, etc.), which may be wired or wireless communication links.

The network 100 may also support mission critical communications with ultra-reliable and redundant links for mission critical devices, such as the UE 115e, which may be a vehicle (e.g., a car, a truck, a bus, an autonomous vehicle, an aircraft, a boat, etc.). Redundant communication links with the UE 115e may include links from the macro BSs 105d and 105e, as well as links from the small cell BS 105f. Other machine type devices, such as the UE 115f (e.g., a thermometer), the UE 115g (e.g., smart meter), and UE 115h (e.g., wearable device) may communicate through the network 100 either directly with BSs, such as the small cell BS 105f, and the macro BS 105e, or in multi-hop configurations by communicating with another user device which relays its information to the network, such as the UE 115f communicating temperature measurement information to the smart meter, the UE 115g, which is then reported to the network through the small cell BS 105f. In some aspects, the UE 115h may harvest energy from an ambient environment associated with the UE 115h. The network 100 may also provide additional network efficiency through dynamic, low-latency TDD/FDD communications, such as vehicle-to-vehicle (V2V), vehicle-to-everything (V2X), cellular-vehicle-to-everything (C-V2X) communications between a UE 115i, 115j, or 115k and other UEs 115, and/or vehicle-to-infrastructure (V2I) communications between a UE 115i, 115j, or 115k and a BS 105.

In some implementations, the network 100 utilizes OFDM-based waveforms for communications. An OFDM-based system may partition the system BW into multiple (K) orthogonal subcarriers, which are also commonly referred to as subcarriers, tones, bins, or the like. Each subcarrier may be modulated with data. In some instances, the subcarrier spacing between adjacent subcarriers may be fixed, and the total number of subcarriers (K) may be dependent on the system BW. The system BW may also be partitioned into subbands. In other instances, the subcarrier spacing and/or the duration of TTIs may be scalable.

In some instances, the BSs 105 can assign or schedule transmission resources (e.g., in the form of time-frequency resource blocks (RB)) for downlink (DL) and uplink (UL) transmissions in the network 100. DL refers to the transmission direction from a BS 105 to a UE 115, whereas UL refers to the transmission direction from a UE 115 to a BS 105. The communication can be in the form of radio frames. A radio frame may be divided into a plurality of subframes, for example, about 10. Each subframe can be divided into slots, for example, about 2. Each slot may be further divided into mini-slots. In a FDD mode, simultaneous UL and DL transmissions may occur in different frequency bands. For example, each subframe includes a UL subframe in a UL frequency band and a DL subframe in a DL frequency band. In a TDD mode, UL and DL transmissions occur at different time periods using the same frequency band. For example, a subset of the subframes (e.g., DL subframes) in a radio frame may be used for DL transmissions and another subset of the subframes (e.g., UL subframes) in the radio frame may be used for UL transmissions.

The DL subframes and the UL subframes can be further divided into several regions. For example, each DL or UL subframe may have pre-defined regions for transmissions of reference signals, control information, and data. Reference signals are predetermined signals that facilitate the communications between the BSs 105 and the UEs 115. For example, a reference signal can have a particular pilot pattern or structure, where pilot tones may span across an operational BW or frequency band, each positioned at a pre-defined time and a pre-defined frequency. For example, a BS 105 may transmit cell specific reference signals (CRSs) and/or channel state information-reference signals (CSI-RSs) to enable a UE 115 to estimate a DL channel. Similarly, a UE 115 may transmit sounding reference signals (SRSs) to enable a BS 105 to estimate a UL channel. Control information may include resource assignments and protocol controls. Data may include protocol data and/or operational data. In some instances, the BSs 105 and the UEs 115 may communicate using self-contained subframes. A self-contained subframe may include a portion for DL communication and a portion for UL communication. A self-contained subframe can be DL-centric or UL-centric. A DL-centric subframe may include a longer duration for DL communication than for UL communication. A UL-centric subframe may include a longer duration for UL communication than for UL communication.

In some instances, the network 100 may be an NR network deployed over a licensed spectrum. The BSs 105 can transmit synchronization signals (e.g., including a primary synchronization signal (PSS) and a secondary synchronization signal (SSS)) in the network 100 to facilitate synchronization. The BSs 105 can broadcast system information associated with the network 100 (e.g., including a master information block (MIB), remaining minimum system information (RMSI), and other system information (OSI)) to facilitate initial network access. In some instances, the BSs 105 may broadcast the PSS, the SSS, and/or the MIB in the form of synchronization signal blocks (SSBs) over a physical broadcast channel (PBCH) and may broadcast the RMSI and/or the OSI over a physical downlink shared channel (PDSCH).

In some instances, a UE 115 attempting to access the network 100 may perform an initial cell search by detecting a PSS from a BS 105. The PSS may enable synchronization of period timing and may indicate a physical layer identity value. The UE 115 may then receive an SSS. The SSS may enable radio frame synchronization, and may provide a cell identity value, which may be combined with the physical layer identity value to identify the cell. The SSS may also enable detection of a duplexing mode and a cyclic prefix length. The PSS and the SSS may be located in a central portion of a carrier or any suitable frequencies within the carrier.

After receiving the PSS and SSS, the UE 115 may receive a MIB. The MIB may include system information for initial network access and scheduling information for RMSI and/or OSI. After decoding the MIB, the UE 115 may receive RMSI and/or OSI. The RMSI and/or OSI may include radio resource control (RRC) information related to random access channel (RACH) procedures, paging, control resource set (CORESET) for physical downlink control channel (PDCCH) monitoring, physical uplink control channel (PUCCH), physical uplink shared channel (PUSCH), power control, SRS, and cell barring.

After obtaining the MIB, the RMSI and/or the OSI, the UE 115 can perform a random access procedure to establish a connection with the BS 105. For the random access procedure, the UE 115 may transmit a random access preamble and the BS 105 may respond with a random access response. Upon receiving the random access response, the UE 115 may transmit a connection request to the BS 105 and the BS 105 may respond with a connection response (e.g., contention resolution message).

After establishing a connection, the UE 115 and the BS 105 can enter a normal operation stage, where operational data may be exchanged. For example, the BS 105 may schedule the UE 115 for UL and/or DL communications. The BS 105 may transmit UL and/or DL scheduling grants to the UE 115 via a PDCCH. The BS 105 may transmit a DL communication signal to the UE 115 via a PDSCH according to a DL scheduling grant. The UE 115 may transmit a UL communication signal to the BS 105 via a PUSCH and/or PUCCH according to a UL scheduling grant.

The network 100 may be designed to enable a wide range of use cases. While in some examples a network 100 may utilize monolithic base stations, there are a number of other architectures which may be used to perform aspects of the present disclosure. For example, a BS 105 may be separated into a remote radio head (RRH) and baseband unit (BBU). BBUs may be centralized into a BBU pool and connected to RRHs through low-latency and high-bandwidth transport links, such as optical transport links. BBU pools may be cloud-based resources. In some aspects, baseband processing is performed on virtualized servers running in data centers rather than being co-located with a BS 105. In another example, based station functionality may be split between a remote unit (RU), distributed unit (DU), and a central unit (CU). An RU generally performs low physical layer functions while a DU performs higher layer functions, which may include higher physical layer functions. A CU performs the higher RAN functions, such as radio resource control (RRC).

For simplicity of discussion, the present disclosure refers to methods of the present disclosure being performed by base stations, or more generally network entities, while the functionality may be performed by a variety of architectures other than a monolithic base station. In addition to disaggregated base stations, aspects of the present disclosure may also be performed by a centralized unit (CU), a distributed unit (DU), a radio unit (RU), a Near-Real Time (Near-RT) RAN Intelligent Controller (RIC), a Non-Real Time (Non-RT) RIC, integrated access and backhaul (IAB) node, a relay node, a sidelink node, etc.

In some aspects, the UE 115a may receive a configuration for a channel state information (CSI) report setting from the BS 105a. A report quantity configured by the CSI report setting may include measured channel characteristics of channel state information reference signal (CSI-RS) resources or synchronization signal block (SSB) resources for channel measurement associated with the CSI report setting and parameters of predicted channel characteristics associated with the CSI-RS resources or the SSB resources for channel measurement associated with the CSI report setting. The UE 115a may transmit a CSI report based on the CSI report setting to the BS 105a.

FIG. 1A illustrates an example of a wireless communications network 200 that supports beam change reporting via prediction based beam management according to some aspects of the present disclosure. The wireless communications network 200 may implement aspects of the wireless communications network 100, 200, 205, or 1000 as described with reference to FIGS. 1, 2A, 2B, and 10. The wireless communications network 200 may include a UE 115a which may be an example of a UE 115 as described herein. The wireless communications network 200 may also include a base station 105a which may be an example of a base station 105 as described herein. In some aspects, the base station 105a may communicate with the UE 115a using directional communications techniques. For example, the base station 105a may communicate with the UE 115a via one or more beams 210. The base station 105a may communicate with the UE 115a via a communication link 125a, which may be an example of an NR or LTE link between the UE 115a and the base station 105a. In some cases, the communication link 125a may include an example of an access link (e.g., Uu link). The communication link 125a may include a bi-directional link that enables both uplink and downlink communication. For example, the UE 115a may transmit uplink signals, such as uplink control signals or uplink data signals, to the base station 105a using the communication link 125a and the base station 105a may transmit downlink signals, such as downlink control signals or downlink data signals, to the UE 115a using the communication link 125a.

As part of transmitting downlink data to the UE 115a via the communication link 125a, the base station 105a may sweep a set of transmission beams (e.g., a first transmission beam 210a, a second transmission beam 210b, and a third transmission beam 210c, etc.) across the communication link 125a according to a beam sweeping pattern. In some aspects, the beam sweeping pattern may include transmitting a set of SSBs across the set of transmission beams 210. The base station 105a may transmit an indication of the beam sweep pattern to the UE 115a. The UE 115a may perform measurements upon the SSBs received across the beams 210 and transmit a CSI report to the base station 105a indicating measured and/or predicted parameters associated with beams 210. For example, the CSI report may indicate a strongest beam at a previous and/or a future time period. The UE 115a and the base station 105a may establish communications over the communication link 125a based on the CSI report. For example, the base station 105a and the UE 115a may perform an SSB beam sweep and report procedure during an initial access procedure (e.g., as part of a random access channel (RACH) procedure). Beams used for SSB beam sweeping may be wide beams (e.g., layer 1 (L1) beams).

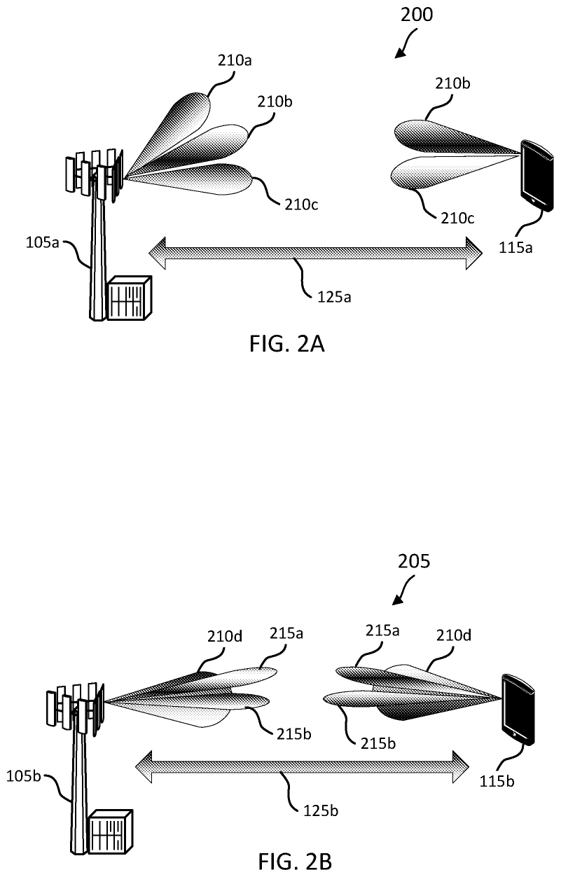

FIG. 2B illustrates an example of a wireless communications network 205 that supports beam change reporting via prediction based beam management according to some aspects of the present disclosure. In some aspects, the wireless communications network 205 may be implemented by or may implement aspects of the wireless communications network 100, 200, 205, or 1000 as described with reference to FIGS. 1, 2A, 2B, and 10. The wireless communications network 205 may include a UE 115b which may be an example of a UE 115 as described herein. The wireless communications network 205 may also include a base station 105b which may be an example of a base station 105 as described herein.

In some aspects, the base station 105b may communicate with the UE 115b using directional communications techniques. For example, the base station 105b may communicate with the UE 115b via one or more beams 210. The base station 105b may communicate with the UE 115b via a communication link 125b, which may be an example of an NR or LTE link between the UE 115b and the base station 105b. In some cases, the communication link 125b may include an example of an access link (e.g., Uu link). The communication link 125b may include a bi-directional link that enables both uplink and downlink communication. For example, the UE 115b may transmit uplink signals, such as uplink control signals or uplink data signals, to the base station 105b using the communication link 125b and the base station 105b may transmit downlink signals, such as downlink control signals or downlink data signals, to the UE 115b using the communication link 125b.

As part of transmitting downlink data to the UE 115b via the respective communication link 125b, the base station 105b may sweep a set of transmission beams 210d across the communication link 125b according to a beam sweeping pattern. In some aspects, the beam sweeping pattern may include transmitting a set of CSI-RSs across the set of transmission beams 210d (e.g., the base station 105b may transmit CSI-RS 215a and CSI-RS 215b). The base station 105b may transmit an indication of the beam sweep pattern to the UE 115b. The UE 115b may perform measurements upon the CSI-RSs received across the beams 210d and transmit a CSI report to the base station 105b indicating channel state information. In some aspects, the base station 105b may indicate a configuration for a CSI report setting associated with measured and/or predicted parameters associated with beams 210 and 215. For example, the CSI report may indicate a strongest predicted beam. The UE 115b and the base station 105b may maintain or update communications over the communication link 125b based on the CSI report. For example, the base station 105b and the UE 115b may periodically perform a CSI-RS beam sweep and report procedure while in an RRC connected mode. In some aspects, the base station 105b and the UE 115b may perform a CSI-RS beam sweep and CSI report procedure as part of a beam failure recovery procedure (e.g., to facilitate recovery) or a radio link failure procedure (e.g., to re-establish communications).

The CSI-RS beam sweep may be a P1, P2, and/or P3 procedure. P1 may be a beam selection procedure where the BS 105b sweeps the beam and the UE 115b selects the strongest beam and reports the strongest beam to the BS 105b. P2 may be a beam refinement procedure for the BS 105b, where the BS 105b may refine a beam (e.g., via sweeping a narrower beam over a narrower range), and the UE 115b may detect and report the strongest beam (e.g., from the set of narrower beams) to the BS 105b. P3 may be a beam refinement procedure for the UE 115b, where the BS 105b may fix a beam (e.g., transmit the same beam repeatedly), and the UE 115b may refine its receiver to optimize receipt of the fixed beam. The BS 105b and the UE 115b may perform a similar processes, but in reverse, for uplink beam management (e.g., U1, U2, and/or U3 procedures).

The UE 115b may report a SSB resource block indicator (SSBRI), a CSI-RS resource indicator (CRI), an L1 reference signal received power (RSRP), and/or an L1 signal-to-noise and interference ratio (SINR) via the CSI report. The UE 115b may receive from the BS 105b a report quantity message indicating which parameters (e.g., SSBRI, CRI, SSB RSRP/SINR, CSI-RS RSRP/SINR, CQI, PMI, LI, RI, etc.) should be measured and reported via the CSI report. For example, the CSI report setting configuration for the UE 115b may include the fields ReportQuantity=ssb-Index-RSRP, ssb-Index-SINR, cri-RSRP, and/or cri-SINR for joint SSBRI/CRI and L1-RSRP/L1-SINR beam reporting. The UE 1115b may report a number of different SSBRIs or CRIs for each CSI report configuration, where the number may be equal to the number of reported reference signals. The number of reported reference signals may be configured via RRC messaging.

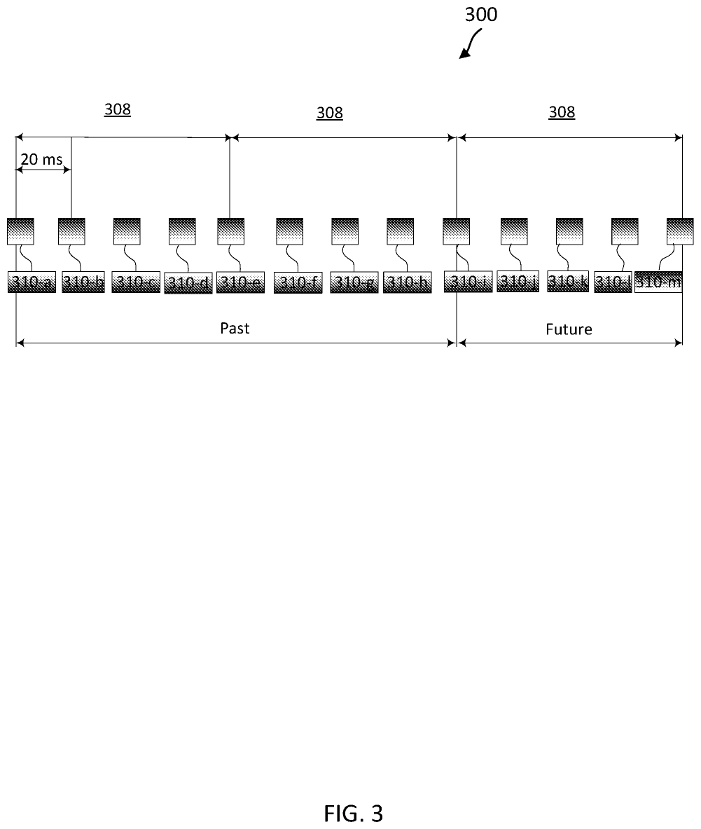

FIG. 3 illustrates an example of a timing diagram 300 that supports beam change reporting via prediction based beam management in accordance with some aspects of the present disclosure. In some aspects, the timing diagram 300 may be implemented by or may implement aspects of the wireless communications network 100, 200, 205, or 1000 as described with reference to FIGS. 1, 2A, 2B, and 10.

In some instances, a UE (e.g., the UE 115 or 800) may predict whether the strongest beam index may change (or change more frequently and/or dynamically) at a future time (or in a future time window). The UE may predict the changes in the strongest beam index using measurements obtained based on a beam management periodicity 308. In some instances, the UE may utilize a beam management periodicity 308 that is longer than a default beam management periodicity (e.g., 20 or 40 ms). In some instances, the beam management periodicity 308 may be greater than 100 ms, including without limitation 200 ms, 300 ms, 400 ms, 500 ms, and/or any other suitable periodicity 308.

In some instances, the UE may utilize less than all available CSI-RS or SSB resources to predict a strongest beam index and/or a change in the strongest beam index. For example, the UE may utilize a subset of measured beams (e.g., 2, 3, 4, 5, 6, 7, 8, etc. measured beams) to predict a strongest beam from a larger set of potential beams (e.g., 12, 16, 18, 20, 24, 32, 64, etc. measured beams). For example, the UE may predict future strongest beam indices 310-j, 310-k, 310-1, and/or 310-m based on the past measured beam indices 310-a, 310-b, 310-c, 310-d, 310-e, 310-f, 310-g, and/or 310-h. In some aspects, the UE may send requests to the BS for decreased beam management periodicity 308 or an increased number of CSI-RS/SSB resources if the strongest beam index is predicted to change or predicted to change more dynamically.

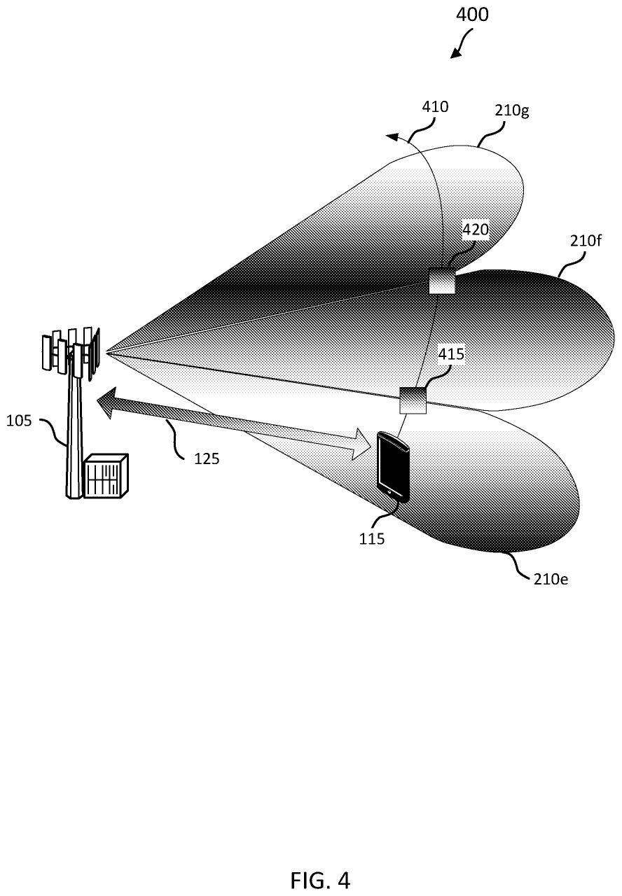

FIG. 4 illustrates an example of a wireless communications system 400 that supports beam change reporting via prediction based beam management in accordance with some aspects of the present disclosure. The wireless communications system 400 may be implemented by or may implement aspects of the wireless communications system 100, 200, 205, or 1000 as described with reference to FIGS. 1, 2A, 2B, and 10. The wireless communications system 400 may include a UE 115 which may be an example of a UE 115 as described herein. The wireless communications system 400 may also include a base station 105 which may be an example of a base station 105 as described herein.

In some examples, the base station 105 may communicate with the UE 115 using directional communications techniques. For example, the BS 105 may communicate with the UE 115 via one or more beams 210. The BS 105 may communicate with the UE 115 via a communication link 125, which may be an example of an NR or LTE link between the UE 115 and the BS 105. In some aspects, the communication link 125 may include an example of an access link (e.g., Uu link). The communication link 125 may include a bi-directional link that enables both uplink and downlink communication. For example, the UE 115 may transmit uplink signals, such as uplink control signals or uplink data signals, to the BS 105 using the communication link 125 and the BS 105 may transmit downlink signals, such as downlink control signals or downlink data signals, to the UE 115 using the communication link 125.

As the UE 115 moves along a path 410, the strongest beam 210 may change. For example, at point 415, the strongest beam may change from beam 210e to beam 210f. At point 420, the strongest beam may change from beam 210f to beam 210g. When the UE 115 moves along the path 410 at a slow speed the beams 210 may largely be stationary (e.g., at a 20 ms beam management cycle, the strongest beam may be unchanged in a majority of the CSI reports).

In some aspects, the UE 115 may report an SSB resource block indicator (SSBRI), a CSI-RS resource indicator (CRI), a layer 1 reference signal received power (RSRP) associated with the CSI-RS resources, and/or a signal-to-noise and interference ratio (SINR) associated with the CSI-RS resources via the CSI report. The UE 115 may receive from the BS 105 a report quantity message indicating which parameters (e.g., SSBRI, CRI, SSB RSRP/SINR, CSI-RS RSRP/SINR, CQI, PMI, LI, RI, etc.) should be measured and reported via the CSI report. For example, the CSI report configuration for the UE 115 may include the fields ReportQuantity=ssb-Index-RSRP, ssb-Index-SINR, cri-RSRP, and/or cri-SINR for joint SSBRI/CRI and L1-RSRP/L1-SINR beam reporting. The UE 115 may report a number of different SSBRIs or CRIs for each CSI report configuration, where the number may be equal to the number of reported reference signals. The number of reported reference signals may be configured via RRC messaging.

In some aspects, the configuration for the CSI report setting may indicate that the CSI report may include parameters of predicted channel characteristics associated with the CSI-RS resources and/or the SSB resources. In some aspects, the UE 115 may be configured to transmit a CSI report periodically (e.g., every 20 ms, 40 ms, 80 ms, etc.). Frequent beam management and transmission of CSI reports (e.g., every 20 ms or 40 ms) may consume UE 115 overhead and/or UE 115 power. In stationary or low mobility UE scenarios, the strongest beam 210 index may not change frequently (e.g., may not change over hundreds of ms, seconds, minutes, or even longer periods of time), therefore the UE 115 may reduce overhead and/or power consumption by predicting a strongest beam 210 change at future time (e.g. the UE 115 at points 415 and 420) and transmitting a CSI report less frequently and/or on request from the BS 105. In some aspects, the UE 115 may use an artificial intelligence based beam prediction technique that may rely on parameters of predicted channel characteristics associated with the CSI-RS resources and/or the SSB resources. For example, the UE 115 may use a convolutional neural network (CNN), a recurrent neural network (RNN), a long short-term memory (LSTM), or the like for predicting parameters of channel characteristics including, without limitation, the strongest beam 210 index.

In some instances, the UE 115 may predict whether the strongest beam 210 index may change (or change more frequently and/or dynamically) at a future time (or in a future time window) as the UE moves along path 410. The UE 115 may predict the changes in the strongest beam 210 index using measurements obtained based on a beam management periodicity. In some instances, the UE 115 may utilize a beam management periodicity that is longer than a default beam management periodicity (e.g., 20 or 40 ms). In some instances, the beam management periodicity may be greater than 100 ms, including without limitation 200 ms, 300 ms, 400 ms, 500 ms, and/or any other suitable periodicity.

In some aspects, the UE 115 may reduce overhead by omitting certain reporting quantities (e.g., predicted parameters) from the CSI report (e.g., intra-report omission). For example, the predicted parameters may be associated with different priorities. The priorities may determine whether the parameters will be included in the CSI report. The UE 115 may determine the priorities associated with the predicted parameters and/or the UE 115 may receive a message from the BS 105 via RRC messaging indicating the priorities. The priorities associated with the predicted parameters may be based on a level of influence the parameter may have on predicting whether the strongest beam 210 may change at a future time period as the UE 115 moves along path 410. For example, a predicted RSRP mean may have a higher priority than a predicted RSRP variance. A predicted strongest beam 210 index may have a higher priority than a predicted RSRP value. A predicted strongest beam 210 change instance at a future time may have a higher priority than a predicted non-changing strongest beam 210 at a future time. When the PUSCH and/or PUCCH resources used to transmit the CSI report are limited, one or more predicted parameters may be omitted from the CSI report based on their associated priorities in order to conserve resources.

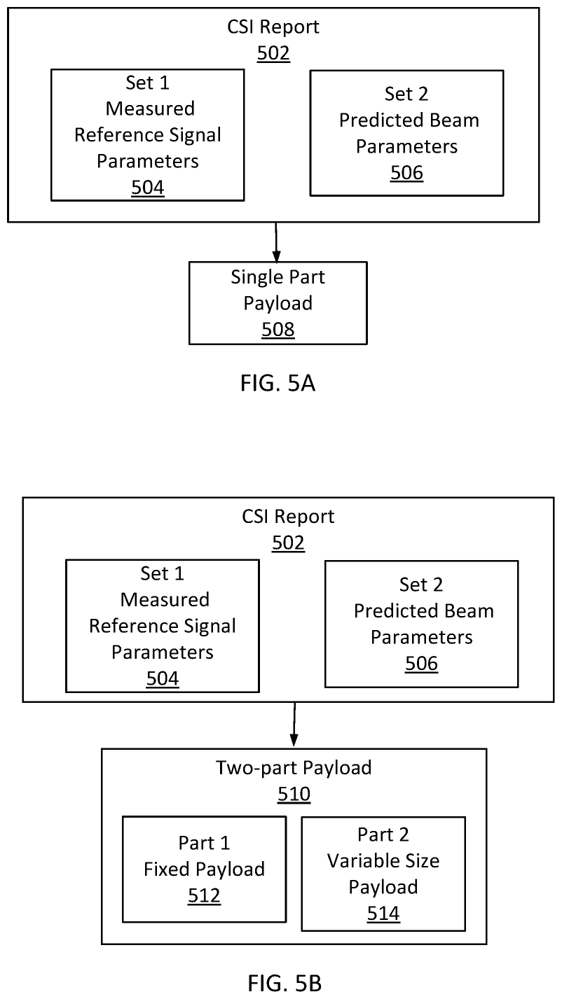

FIG. 5A illustrates a CSI report 502 payload structure according to some aspects of the present disclosure. In some aspects, the UE may transmit the CSI report 502 to the BS based on the CSI report 502 setting. In this regard, the UE may transmit the CSI report 502 to the BS using any suitable payload structure and channel(s). For example, the UE may transmit the measured channel characteristics 504 and the predicted parameters 506 in a single-part payload 508 via a physical uplink shared channel (PUSCH). In some aspects, the UE may transmit the measured channel characteristics 504 and the predicted parameters 506 in a single-part payload 508 via a PUCCH. For example, the UE may transmit the measured channel characteristics 504 (e.g., SSBRI, CRI, SSB RSRP/SINR, CSI-RS RSRP/SINR, CQI, PMI, LI, RI, etc.) and the predicted parameters 506 (e.g., strongest SSBRI(s)/CRI(s), ordering of the strongest SSBRI(s)/CRI(s), SSB RSRP/SINR, CSI-RS RSRP/SINR, probability/mean/variance of the strongest SSBRI(s)/CRI(s) CQI, PMI, RI, etc.) in a single-part payload 508 via a PUCCH.

In some aspects, the single-part payload 508 may include the measured channel characteristics 504 and/or the predicted parameters 506 of the predicted channel characteristics. In this regard, the single-part payload 508 may include a fixed size payload having a number of code points (e.g., 128 code points). For example, in L1 RSRP reporting, for the strongest SSBRI, 7 bits may be used to report the RSRP in the range of −140 dBm to −44 dBm with a 1 dBm step size. For the remaining SSBRIs or CRIs, 4 bits may be used to report a differential RSRP in the range of 0 dB to −30 dB with a 2 dB step size and a reference to the strongest SSBRI or CRI's L1 RSRP. For the strongest SSBRI or CRI's L1 RSRP, there are 31 invalid code points (128-97) since 2\hat{ }7=128 code points are available in the 7 bits, but only 140−44+1=97 code points are the valid code points. In some aspects, the number of code points considered valid or invalid may be based on a level of standards (e.g., 3GPP standards) compliance of the UE and/or the BS.

In some aspects, the single-part payload 508 may include both the measured channel characteristics 504 and the predicted parameters 506 being carried in any suitable combination of fixed code points. For example, the measured channel characteristics 504 and the predicted parameters 506 may be carried by the valid code points of the single-part payload 508, the measured channel characteristics may be carried by the valid code points while the predicted parameters may be carried by the invalid code points, and/or the measured channel characteristics 504 and the predicted parameters 506 may be carried by the invalid code points of the single-part payload 508.

In some aspects, the CSI report 502 comprising a single-part payload 508 may include measured channel characteristics 504 such as the SSB-index-RSRP of a set of the strongest SSBRIs (e.g., the four strongest SSBRIs) and the predicted parameters 506. The predicted parameters 506 may include an indicator indicating the predicted strongest SSBRI will remain the same as the most recent measured strongest SSBRI for a period of time (e.g., 20 ms, 40 ms, 80 ms, or more). The CSI report 502 may include the period of time over which the predicted strongest SSBRI will remain the same as the most recent measured strongest SSBRI. In some aspects, the predicted parameters 506 may include an indicator indicating the predicted strongest SSBRI will change at a future point in time. The future point in time may be relative to the time of the most recently received SSBs. The CSI report 502 may include an indicator indicating when the predicted strongest SSBRI will change, the SSBRI that the strongest SSBRI will change to, a probability associated with the predicted strongest SSBRI, an RSRP associated with the SSBRI that the strongest SSBRI will change to, a predicted mean of the RSRP associated with the SSBRI that the strongest SSBRI will change to, and/or a predicted variance of the RSRP associated with the SSBRI that the strongest SSBRI will change to.

The UE may transmit the CSI report 502 to the BS based on a periodic basis or a semi-persistent basis. In this regard, the UE may receive an indicator from the BS via RRC messaging indicating the periodicity at which the UE may transmit the CSI report 502. In some aspects, the UE may receive a request from the BS requesting a CSI report 502. The UE may transmit the CSI report 502 to the BS in response to the request.

FIG. 5B illustrates a CSI report 502 payload structure according to some aspects of the present disclosure. In some aspects, the UE may transmit the CSI report 502 to the BS using any suitable payload structure and channel(s). For example, the UE may transmit the measured channel characteristics 504 and the predicted parameters 506 in a two-part payload 510 via a PUSCH and/or a PUCCH. In some aspects, the UE may transmit the measured channel characteristics 504 (e.g., SSBRI, CRI, SSB RSRP/SINR, CSI-RS RSRP/SINR, CQI, PMI, LI, RI, etc.) in a first part 512 of a two-part payload 510 via a physical uplink control channel (PUCCH) while the predicted parameters 506 (e.g., strongest SSBRI(s)/CRI(s), ordering of the strongest SSBRI(s)/CRI(s), SSB RSRP/SINR, CSI-RS RSRP/SINR, probability/mean/variance of the strongest SSBRI(s)/CRI(s) CQI, PMI, RI, etc.) are transmitted via a second part 514 of the two-part payload 510 via a PUSCH. In this case, the PUCCH may include a scheduling request for transmitting the second part 514 via the PUSCH. In some aspects, the UE may transmit both the measured channel characteristics 504 and the predicted parameters 506 in a two-part payload 510 via a PUCCH.

In some aspects, the two-part payload 510 may include a first part 512 having a fixed payload size and a second part 514 having a payload size based on at least one of the measured channel characteristics 504 included in the first part 512 or the predicted parameters 506 included in the first part 512. In some aspects, the first part 512 may include the measured channel characteristics 504 while the second part 514 includes the predicted parameters 506. The first part 512 may include an indicator indicating which predicted parameter 506 quantities (e.g., strongest SSBRI(s)/CRI(s), probability, mean, variance, PMI, RI, LI, CQI, etc.) are included in the second part 514. The first part 512 of the two-part payload 510 may also indicate the size of the second part 514 of the two-part payload 510. The UE may receive a configuration from the BS via a RRC message indicating the predicted parameter 506 quantities to be included in the second part 514. The payload size of the second part 514 may be variable and based on the predicted parameter 506 quantities to be included in the second part 514. In some aspects, the second part 514 may be compressed using a lossless data compression algorithm to reduce the size of the second part payload 514. In some aspects, the size of the second part payload 514 may be reduced by a differential reporting method in which the predicted parameters 506 are reported as a differential to a previous second part 514.

In some aspects, the first part 512 may include the measured channel characteristics 504 and a first portion of the predicted parameters 506 while the second part 514 includes a second portion (e.g., a remaining portion) of the predicted parameters 506. For example, the first part 512 of the two-part payload 510 may include an indicator that the strongest SSBRI will change at a future time while the second part 514 includes the time when the strongest SSBRI will change and/or the RSRP of the predicted strongest SSBRI.

In some aspects, the first part 510 may include an indicator indicating the CSI report 502 comprises only the first part 512. In this regard, the UE may only transmit the first part 512 of the two-part payload 510 to the BS further reducing overhead and resources. The indicator indicating the CSI report comprises only the first part 512 may indicate to the BS that the strongest SSBRI/CRI will remain the same before the next CSI reporting period. The UE may continue to include only the first part 512 in the CSI report for each reporting period until the UE predicts that the strongest SSBRI/CRI will change.

In some aspects, predetermined code points in the CSI report 502 may indicate the single-part, fixed-payload CSI report 502 includes the predicted parameters 506. In this regard, the UE may receive an indicator from the BS via an RRC message indicating the predetermined code points that indicate the CSI report includes the predicted parameters 506. For example, a set of predetermined L1-RSRP/SINR code points may indicate that the predicted parameters 506 are included in the CSI report 502. The set of predetermined L1-RSRP/SINR code points may include invalid code points for the strongest SSBRI/CRI's L1-RSRP. As another example, a predetermined code point (e.g., a single bit) in the CSI report 502 may indicate the CSI report 502 includes the predicted parameters 506.

In some aspect, the UE may indicate an invalid RSRP of a beam in the CSI report 502 to indicate to the BS to reinterpret the single-part, fixed-payload CSI report 502. For example, the UE may indicate via a predetermined code point and/or an invalid RSRP of a beam to the BS to interpret the quantities in the CSI report 502 as predicted parameters 506 rather than measured channel characteristics 504. Different predetermined code points may indicate different predicted parameters 506 are included in the CSI report 502.

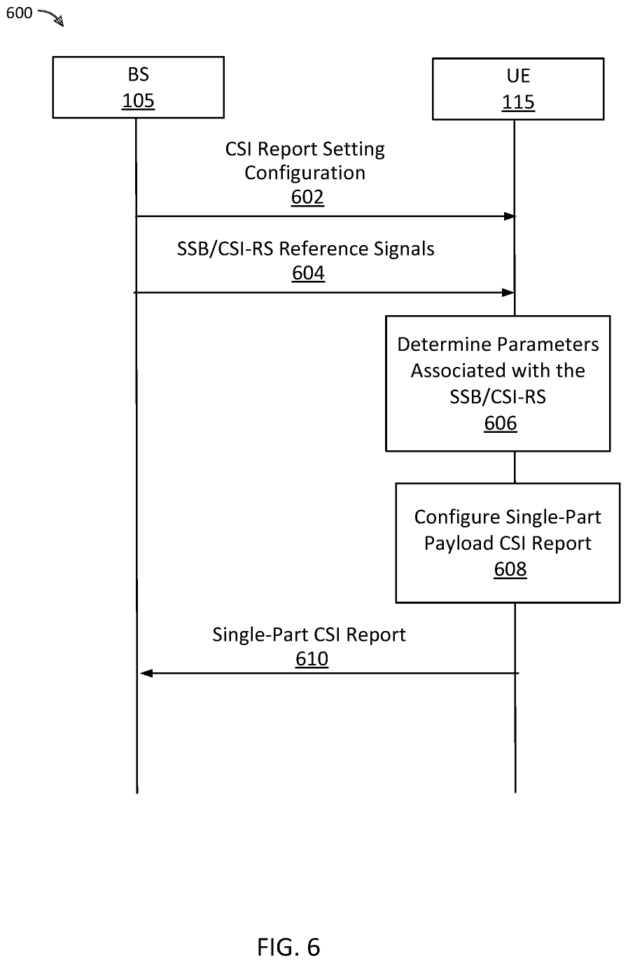

FIG. 6 is a signaling diagram of a communication method 600 according to some aspects of the present disclosure. Actions of the communication method 600 can be executed by a computing device (e.g., a processor, processing circuit, and/or other suitable component) of a communication device or other suitable means for performing the actions. For example, a wireless communication device, such as the UE 115 or UE 800, may utilize one or more components, such as the processor 802, the memory 804, the CSI reporting module 808, the transceiver 810, the modem 812, and the one or more antennas 816, to execute aspects of method 600. For example, a wireless communication device, such as the BS 105 or BS 900 may utilize one or more components, such as the processor 902, the memory 904, the CSI reporting module 908, the transceiver 910, the modem 912, and the one or more antennas 916, to execute aspects of method 600.

At action 602, the BS 105 may transmit a configuration for a CSI report setting to the UE 115. In this regard, the BS 105 may transmit the configuration for the CSI report setting to the UE 115 via a radio resource control (RRC) message, downlink control information (DCI), or other suitable control message. The configuration for the CSI report setting may include measured channel characteristics of channel state information reference signal (CSI-RS) resources and/or synchronization signal block (SSB) resources for channel measurement associated with the CSI report setting. The configuration for the CSI report setting may include, without limitation, a periodicity associated with transmitting the CSI report, the measured parameters to be included in the CSI report (e.g., SSBRI, CRI, SSB RSRP/SINR, CSI-RS RSRP/SINR, CQI, PMI, LI, RI), the predicted parameters to be included in the CSI report (e.g., strongest SSBRI(s)/CRI(s), ordering of the strongest SSBRI(s)/CRI(s), SSB RSRP/SINR, CSI-RS RSRP/SINR, probability/mean/variance of the strongest SSBRI(s)/CRI(s), CQI, PMI, LI, RI), the format of the CSI report (single-part fixed payload, two-part fixed/variable payload), priorities associated with the predicted parameters, the physical channel(s) to carry the CSI report (e.g., PUCCH, PUSCH), and/or other information regarding the content and/or transmission of the CSI report.

At action 604, the BS 105 may transmit SSB and/or CSI-RS reference signals to the UE 115. In this regard, the BS 105 may sweep a set of transmission beams (e.g., a first transmission beam, a second transmission beam, a third transmission beam, etc.) across a communication link to the UE 115 according to a beam sweep pattern. The beam sweeping pattern may include transmitting a set of SSBs and/or CSI-RSs across the set of transmission beams. The BS 105 may transmit an indication of the beam sweep pattern to the UE 115.

At action 606, the UE 115 may determine parameters associated with the SSB(s)/CSI-RS(s). In this regard, the UE 115 may perform measurements upon the SSB(s)/CSI-RS(s) transmitted at action 604. The UE 115 may measure RSRP and/or SINR associated with the SSB(s)/CSI-RS(s). The UE 115 may predict parameters associated with SSB(s)/CSI-RS(s) at a future time. The UE may determine the parameters based upon the CSI report setting configuration received at action 602.

In some aspects, the configuration for the CSI report setting may indicate that the CSI report may include an indicator indicating whether an RSRP and/or SINR of the predicted channel characteristics is stronger than a RSRP/SINR of the measured channel characteristics. For example, the UE 115 may predict the RSRP/SINR of an SSB and/or a CSI-RS at a future time. The UE 115 may compare the predicted RSRP/SINR to a measured RSRP/SINR of an SSB and/or CSI-RS (e.g., measured over one or more time periods) and determine if the predicted RSRP/SINR is stronger (e.g., higher) than the measured RSRP/SINR. If the predicted RSRP/SINR is stronger than the measured RSRP/SINR, the UE 115 may indicate such in the CSI report. In some aspects, the UE 115 may indicate an index associated with the predicted strongest SSB and/or strongest CSI-RS in the CSI report. In some aspects, the UE 115 may predict the RSRP/SINR of a set of SSBs and/or a set of CSI-RSs at a future time. The set of SSBs and/or the set of CSI-RSs may be associated with a set of beams (e.g., a set of adjacent and/or partially overlapping beams). The UE 115 may predict the RSRP/SINR of each SSB of the set of SSBs and/or each CSI-RS of the set of CSI-RSs. The UE 115 may order the set of SSBs and/or the set of CSI-RSs based on their predicted RSRP/SINR. The UE 115 may order the set of SSBs and/or the set of CSI-RSs based on a decreasing value of their predicted RSRP/SINR (e.g., highest RSRP/SINR ranked first, next highest RSRP/SINR ranked second, etc.). The UE 115 may report the ordered set of predicted RSRP/SINR of each SSB of the set of SSBs and/or each CSI-RS of the set of CSI-RSs. In some aspects, the UE 115 may report the ordered set of predicted RSRP/SINR of a subset of SSBs (e.g., highest 3 SSBs) of the set of SSBs and/or a subset of CSI-RSs (e.g., highest 3 CSI-RSs) of the set of CSI-RSs. The UE 115 may report the indexes associated with the ordered set of predicted RSRP/SINRs and/or the values (e.g., dBm values) of the ordered set of predicted RSRP/SINRs in the CSI report.

In some aspects, the configuration for the CSI report setting may indicate that the CSI report may include prediction probabilities associated with one or more of the predicted parameters. For example, the UE 115 may predict the RSRPs/SINRs associated with the beams at a future time using an artificial intelligence (AI) algorithm (e.g., a softmax model). The AI algorithm may produce a probability associated with the predicted RSRPs/SINRs. The probability may be a confidence score that indicates a level of confidence associated with the predicted RSRPs/SINRs. The probability may be represented as a value between 0 and 1 where a higher value indicates a higher level of confidence in the predicted RSRPs/SINRs.

In some aspects, the configuration for the CSI report setting may indicate that the CSI report may include a mean (e.g., an average) associated with one or more of the predicted channel characteristics. For example, the UE 115 may predict the RSRPs/SINRs associated with the beams at a future time. The UE 115 may determine a mean value of the predicted RSRPs/SINRs for a set of beams by summing all the RSRPs/SINRs values and dividing by the number of values. In some aspects, the UE 115 may predict a number of values of the RSRPs/SINRs associated with a set of beams over a future time period and average those values over the time period.

In some aspects, the configuration for the CSI report setting may indicate that the CSI report may include a variance associated with one or more of the predicted parameters. For example, the UE 115 may predict the RSRPs/SINRs associated with the beams at a future time using an AI algorithm (e.g., an AI model). The variance may be the variability in the AI algorithm prediction. The UE 115 may determine a variance of the predicted RSRPs/SINRs for a set of beams and report the variance in the CSI report.

In some aspects, the configuration for the CSI report setting may indicate that the CSI report may include a precoding matrix indicator (PMI) associated with one or more of the predicted parameters. For example, the UE 115 may predict the PMI associated with the beams at a future time. In this regard, the CSI report may include a predicted PMI and/or codebook-based indicator (e.g., a multi-panel type codebook, a linear combination type codebook, a port selection type codebook) associated with the beams at a future time.

In some aspects, the configuration for the CSI report setting may indicate that the CSI report may include a rank indicator (RI) associated with one or more of the predicted parameters. For example, the UE 115 may predict the RI associated with the beams at a future time. The UE 115 may determine the correlation between the different signals received at each receive antenna of the UE 115. The best performance may occur when signals are not correlated between the beams. The correlation may indicate a level of interference between the beams. The number of useful layers may depend upon a corresponding high number of uncorrelated propagation paths between the beams. The CSI report may include a predicted RI associated with the beams at a future time.

In some aspects, the configuration for the CSI report setting may indicate that the CSI report may include a layer indicator (LI) associated with one or more of the predicted parameters. For example, the UE 115 may predict the LI associated with the beams at a future time. The LI may identify the strongest layer from the set of layers indicated by the predicted RI.

In some aspects, the configuration for the CSI report setting may indicate that the CSI report may include a channel quality indicator (CQI) associated with one or more of the predicted parameters. For example, the UE 115 may predict the CQI associated with the beams at a future time. In this regard, the CQI may indicate the highest modulation scheme and the coding rate (MCS) suitable for downlink transmissions to achieve a certain block error rate (BLER) associated with the beams at a future time.

At action 608, the UE 115 may configure the CSI report as a single-part payload. The single-part payload may include the measured channel characteristics and/or the parameters of the predicted channel characteristics. In this regard, the single-part payload may include a fixed size payload having a number of code points (e.g., 128 code points). For example, in L1 RSRP reporting, for the strongest SSBRI, 7 bits may be used to report the RSRP in the range of −140 dBm to −44 dBm with a 1 dBm step size. For the remaining SSBRIs or CRIs, 4 bits may be used to report a differential RSRP in the range of 0 dB to −30 dB with a 2 dB step size and a reference to the strongest SSBRI or CRI's L1 RSRP. For the strongest SSBRI or CRI's L1 RSRP, there are 31 invalid code points (128-97) since 2\hat{ }7=128 code points are available in the 7 bits, but only 140−44+1=97 code points are the valid code points.

In some aspects, the single-part payload may include both the measured channel characteristics and the predicted parameters being carried in any suitable combination of fixed code points. For example, the measured channel characteristics and the predicted parameters may be carried by the valid code points of the single-part payload, the measured channel characteristics may be carried by the valid code points while the predicted parameters may be carried by the invalid code points, and/or the measured channel characteristics and the predicted parameters may be carried by the invalid code points of the single-part payload.

In some aspects, the CSI report comprising a single-part payload may include measured parameters such as the SSB-index-RSRP of a set of the strongest SSBRIs (e.g., the four strongest SSBRIs) and the predicted parameters. The predicted parameters may include an indicator indicating the predicted strongest SSBRI will remain the same as the most recent measured strongest SSBRI for a period of time (e.g., 20 ms, 40 ms, 80 ms, or more). The CSI report may include the period of time over which the predicted strongest SSBRI will remain the same as the most recent measured strongest SSBRI. In some aspects, the predicted parameters may include an indicator indicating the predicted strongest SSBRI will change at a future point in time. The future point in time may be relative to the time of the most recently received SSBs. The CSI report may include an indicator indicating when the predicted strongest SSBRI will change, the SSBRI that the strongest SSBRI will change to, a probability associated with the predicted strongest SSBRI, an RSRP associated with the SSBRI that the strongest SSBRI will change to, a predicted mean of the RSRP associated with the SSBRI that the strongest SSBRI will change to, and/or a predicted variance of the RSRP associated with the SSBRI that the strongest SSBRI will change to.

At action 610, the UE 115 may transmit the single-part CSI report to the BS 105. In some aspects, the UE 115 may transmit the CSI report to the BS 105 based on the CSI report setting configuration received at action 602. In this regard, the UE 115 may transmit the CSI report to the BS 105 using a single-part payload and any suitable channel(s). For example, the UE 115 may transmit the measured parameters and the predicted parameters in a single-part payload via a PUSCH. In some aspects, the UE 115 may transmit the measured parameters and the predicted parameters in a single-part payload via a PUCCH. For example, the UE 115 may transmit the measured parameters (e.g., SSBRI, CRI, SSB RSRP/SINR, CSI-RS RSRP/SINR, CQI, PMI, LI, RI, etc.) and the predicted parameters (e.g., strongest SSBRI(s)/CRI(s), ordering of the strongest SSBRI(s)/CRI(s), SSB RSRP/SINR, CSI-RS RSRP/SINR, probability/mean/variance of the strongest SSBRI(s)/CRI(s) CQI, PMI, RI, etc.) in a single-part payload via a PUCCH and/or a PUSCH.

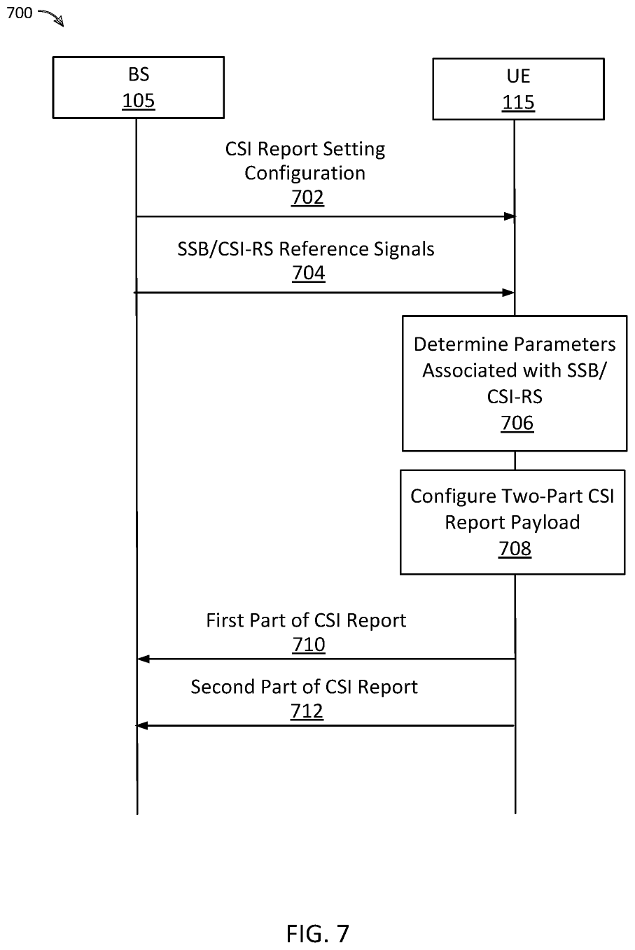

FIG. 7 is a signaling diagram of a communication method 700 according to some aspects of the present disclosure. Actions of the communication method 700 can be executed by a computing device (e.g., a processor, processing circuit, and/or other suitable component) of a communication device or other suitable means for performing the actions. For example, a wireless communication device, such as the UE 115 or UE 800, may utilize one or more components, such as the processor 802, the memory 804, the CSI reporting module 808, the transceiver 810, the modem 812, and the one or more antennas 816, to execute aspects of method 700. For example, a wireless communication device, such as the BS 105 or BS 900 may utilize one or more components, such as the processor 902, the memory 904, the CSI reporting module 908, the transceiver 910, the modem 912, and the one or more antennas 916, to execute aspects of method 700.

At action 702, the BS 105 may transmit a configuration for a CSI report setting to the UE 115. In this regard, the BS 105 may transmit the configuration for the CSI report setting to the UE 115 via a radio resource control (RRC) message, downlink control information (DCI), or other suitable control message. The configuration for the CSI report setting may include measured channel characteristics of channel state information reference signal (CSI-RS) resources and/or synchronization signal block (SSB) resources for channel measurement associated with the CSI report setting. The configuration for the CSI report setting may include, without limitation, a periodicity associated with transmitting the CSI report, the measured parameters to be included in the CSI report (e.g., SSBRI, CRI, SSB RSRP/SINR, CSI-RS RSRP/SINR, CQI, PMI, LI, RI), the predicted parameters to be included in the CSI report (e.g., strongest SSBRI(s)/CRI(s), ordering of the strongest SSBRI(s)/CRI(s), SSB RSRP/SINR, CSI-RS RSRP/SINR, probability/mean/variance of the strongest SSBRI(s)/CRI(s), CQI, PMI, LI, RI), the format of the CSI report (single-part fixed payload, two-part fixed/variable payload), priorities associated with the predicted parameters, the physical channel(s) to carry the CSI report (e.g., PUCCH, PUSCH), and/or other information regarding the content and/or transmission of the CSI report.

At action 704, the BS 105 may transmit SSB and/or CSI-RS reference signals to the UE 115. In this regard, the BS 105 may sweep a set of transmission beams (e.g., a first transmission beam, a second transmission beam, a third transmission beam, etc.) across a communication link to the UE 115 according to a beam sweep pattern. The beam sweeping pattern may include transmitting a set of SSBs and/or CSI-RSs across the set of transmission beams. The BS 105 may transmit an indication of the beam sweep pattern to the UE 115 via RRC signaling and/or DCI.

At action 706, the UE 115 may determine parameters associated with the SSB(s)/CSI-RS(s). In this regard, the UE 115 may perform measurements upon the SSB(s)/CSI-RS(s) transmitted at action 704. The UE 115 may measure RSRP and/or SINR associated with the SSB(s)/CSI-RS(s). The UE 115 may predict parameters associated with SSB(s)/CSI-RS(s) at a future time. The UE may determine the parameters based upon the CSI report setting configuration received at action 702.

In some aspects, the configuration for the CSI report setting may indicate that the CSI report may include an indicator indicating whether an RSRP and/or an SINR of the predicted channel characteristics is stronger than an RSRP/SINR of the measured channel characteristics. For example, the UE 115 may predict the RSRP/SINR of an SSB and/or a CSI-RS at a future time. The UE 115 may compare the predicted RSRP/SINR to a measured RSRP/SINR of an SSB and/or CSI-RS (e.g., measured over one or more time periods) and determine if the predicted RSRP/SINR is stronger (e.g., higher) than the measured RSRP/SINR. If the predicted RSRP/SINR is stronger than the measured RSRP/SINR, the UE 115 may indicate such in the CSI report. In some aspects, the UE 115 may indicate an index associated with the predicted strongest SSB and/or strongest CSI-RS in the CSI report. In some aspects, the UE 115 may predict the RSRP/SINR of a set of SSBs and/or a set of CSI-RSs at a future time. The set of SSBs and/or the set of CSI-RSs may be associated with a set of beams (e.g., a set of adjacent and/or partially overlapping beams). The UE 115 may predict the RSRP/SINR of each SSB of the set of SSBs and/or each CSI-RS of the set of CSI-RSs. The UE 115 may order the set of SSBs and/or the set of CSI-RSs based on their predicted RSRP/SINR. The UE 115 may order the set of SSBs and/or the set of CSI-RSs based on a decreasing value of their predicted RSRP/SINR (e.g., highest RSRP/SINR ranked first, next highest RSRP/SINR ranked second, etc.). The UE 115 may report the ordered set of predicted RSRP/SINR of each SSB of the set of SSBs and/or each CSI-RS of the set of CSI-RSs. In some aspects, the UE 115 may report the ordered set of predicted RSRP/SINR of a subset of SSBs (e.g., highest 3 SSBs) of the set of SSBs and/or a subset of CSI-RSs (e.g., highest 3 CSI-RSs) of the set of CSI-RSs. The UE 115 may report the indexes associated with the ordered set of predicted RSRP/SINRs and/or the values (e.g., dBm values) of the ordered set of predicted RSRP/SINRs in the CSI report.

At action 708, the UE 115 may configure the CSI report as a two-part payload. The two-part payload may include the measured channel characteristics and/or the parameters of the predicted channel characteristics. The two-part payload may include a first part having a fixed payload size and a second part having a payload size based on at least one of the measured channel characteristics included in the first part or the parameters of the predicted channel characteristics included in the first part. In some aspects, the first part may include the measured channel characteristics while the second part includes the predicted parameters. The first part may include an indicator indicating which predicted parameter quantities (e.g., strongest SSBRI(s)/CRI(s), probability, mean, variance, PMI, RI, LI, CQI, etc.) are included in the second part. The first part of the two-part payload may also indicate the size of the second part of the two-part payload. The CSI report setting configuration received at action 702 may indicate the predicted parameter quantities to be included in the second part. The payload size of the second part may be variable and based on the predicted parameter quantities to be included in the second part. In some aspects, the second part may be compressed using a lossless data compression algorithm to reduce the size of the second part payload. In some aspects, the size of the second part payload may be reduced by a differential reporting method where the predicted parameters are reported as a differential to a previous second part CSI report.

In some aspects, the first part may include the measured channel characteristics and a first portion of the predicted parameters while the second part includes a second portion (e.g., a remaining portion) of the predicted parameters. For example, the first part of the two-part payload may include an indicator that the strongest SSBRI will change at a future time while the second part includes the time when the strongest SSBRI will change and/or the RSRP of the predicted strongest SSBRI.

In some aspects, the first part of the CSI report may include an indicator indicating the CSI report comprises only the first part. In this regard, the UE 115 may only transmit the first part of the two-part payload to the BS 105 further reducing overhead and resources. The indicator indicating the CSI report comprises only the first part may indicate to the BS 105 that the strongest SSBRI/CRI will remain the same before the next CSI reporting period. The UE 115 may continue to include only the first part in the CSI report for each reporting period until the UE 115 predicts that the strongest SSBRI/CRI will change.

In some aspects, predetermined code points in the CSI report may indicate the single-part, fixed-payload CSI report includes the predicted parameters. The CSI report setting configuration received at action 702 may indicate the predetermined code points that indicate the CSI report includes the predicted parameters. For example, a set of predetermined L1-RSRP/SINR code points may indicate that the predicted parameter quantities are included in the CSI report. The set of predetermined L1-RSRP/SINR code points may include invalid code points for the strongest SSBRI/CRI's L1-RSRP. As another example, a predetermined code point (e.g., a single bit) in the CSI report may indicate the CSI report includes the predicted parameters.

In some aspect, the UE 115 may indicate an invalid RSRP of a beam in the CSI report to indicate to the BS 105 to reinterpret the single-part, fixed-payload CSI report. For example, the UE 115 may indicate via a predetermined code point and/or an invalid RSRP of a beam to the BS 105 to interpret the quantities in the CSI report as predicted parameters rather than measured parameters. Different predetermined code points may indicate different predicted parameters are included in the CSI report.

At action 710, the UE 115 may transmit the first part of the two-part CSI report to the BS 105.

At action 712, the UE 115 may transmit the second part of the two-part CSI report to the BS 105.

In some aspects, the UE 115 may transmit the first part and/or the second part of the CSI report to the BS 105 based on the CSI report setting configuration received at action 702. In some aspects, the UE 115 may transmit the first part and/or the second part of the CSI report to the BS 105 using any suitable channel(s). For example, the UE 115 may transmit the first part and/or the second part of the via a PUSCH. In some aspects, the UE may transmit the first part of the two-part payload via a PUCCH and the second part of the two-part payload via a PUSCH. In this case, the PUCCH may include a scheduling request for transmitting the second part via the PUSCH. In some aspects, the UE may transmit the first part and/or the second part of the two-part payload via a PUCCH.

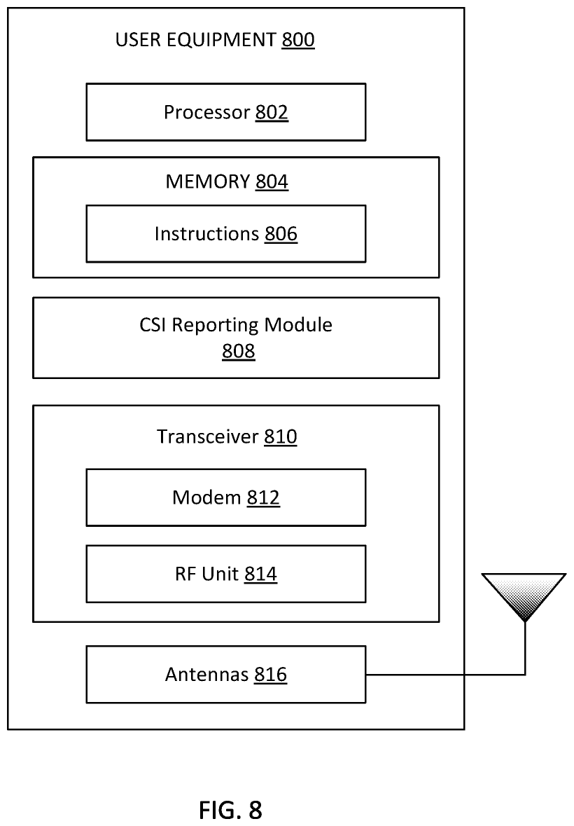

FIG. 8 is a block diagram of an exemplary UE 800 according to some aspects of the present disclosure. The UE 800 may be the UE 115 in the network 100, 200, 205, or 1000. As shown, the UE 800 may include a processor 802, a memory 804, a CSI reporting module 808, a transceiver 810 including a modem subsystem 812 and a radio frequency (RF) unit 814, and one or more antennas 816. These elements may be coupled with each other and in direct or indirect communication with each other, for example via one or more buses.

The processor 802 may include a central processing unit (CPU), a digital signal processor (DSP), an application specific integrated circuit (ASIC), a controller, a field programmable gate array (FPGA) device, another hardware device, a firmware device, or any combination thereof configured to perform the operations described herein. The processor 802 may also be implemented as a combination of computing devices, e.g., a combination of a DSP and a microprocessor, a plurality of microprocessors, one or more microprocessors in conjunction with a DSP core, or any other such configuration.

The memory 804 may include a cache memory (e.g., a cache memory of the processor 802), random access memory (RAM), magnetoresistive RAM (MRAM), read-only memory (ROM), programmable read-only memory (PROM), erasable programmable read only memory (EPROM), electrically erasable programmable read only memory (EEPROM), flash memory, solid state memory device, hard disk drives, other forms of volatile and non-volatile memory, or a combination of different types of memory. In some instances, the memory 804 includes a non-transitory computer-readable medium. The memory 804 may store instructions 806. The instructions 806 may include instructions that, when executed by the processor 802, cause the processor 802 to perform the operations described herein with reference to the UEs 115 in connection with aspects of the present disclosure, for example, aspects of FIGS. 2A, 2B, 3, 4, 5A, 5B, 6, 7, and 10-11. Instructions 806 may also be referred to as code. The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The CSI reporting module 808 may be implemented via hardware, software, or combinations thereof. For example, the CSI reporting module 808 may be implemented as a processor, circuit, and/or instructions 806 stored in the memory 804 and executed by the processor 802. In some aspects, the CSI reporting module 808 may be configured to receive a configuration for a CSI report setting from a BS (e.g., the BS 105 or 900). A report quantity configured by the CSI report setting may include measured channel characteristics of channel state information reference signal (CSI-RS) resources or synchronization signal block (SSB) resources for channel measurement associated with the CSI report setting and parameters of predicted channel characteristics associated with the CSI-RS resources or the SSB resources for channel measurement associated with the CSI report setting. The CSI reporting module 808 may be configured to transmit, to the BS, a CSI report based on the CSI report setting.

As shown, the transceiver 810 may include the modem subsystem 812 and the RF unit 814. The transceiver 810 can be configured to communicate bi-directionally with other devices, such as the BSs 105 and/or the UEs 115. The modem subsystem 812 may be configured to modulate and/or encode the data from the memory 804 and the according to a modulation and coding scheme (MCS), e.g., a low-density parity check (LDPC) coding scheme, a turbo coding scheme, a convolutional coding scheme, a digital beamforming scheme, etc. The RF unit 814 may be configured to process (e.g., perform analog to digital conversion or digital to analog conversion, etc.) modulated/encoded data from the modem subsystem 812 (on outbound transmissions) or of transmissions originating from another source such as a UE 115 or a BS 105. The RF unit 814 may be further configured to perform analog beamforming in conjunction with the digital beamforming. Although shown as integrated together in transceiver 810, the modem subsystem 812 and the RF unit 814 may be separate devices that are coupled together to enable the UE 800 to communicate with other devices.

The RF unit 814 may provide the modulated and/or processed data, e.g. data packets (or, more generally, data messages that may contain one or more data packets and other information), to the antennas 816 for transmission to one or more other devices. The antennas 816 may further receive data messages transmitted from other devices. The antennas 816 may provide the received data messages for processing and/or demodulation at the transceiver 810. The antennas 816 may include multiple antennas of similar or different designs in order to sustain multiple transmission links. The RF unit 814 may configure the antennas 816.

In some instances, the UE 800 can include multiple transceivers 810 implementing different RATs (e.g., NR and LTE). In some instances, the UE 800 can include a single transceiver 810 implementing multiple RATs (e.g., NR and LTE). In some instances, the transceiver 810 can include various components, where different combinations of components can implement RATs.

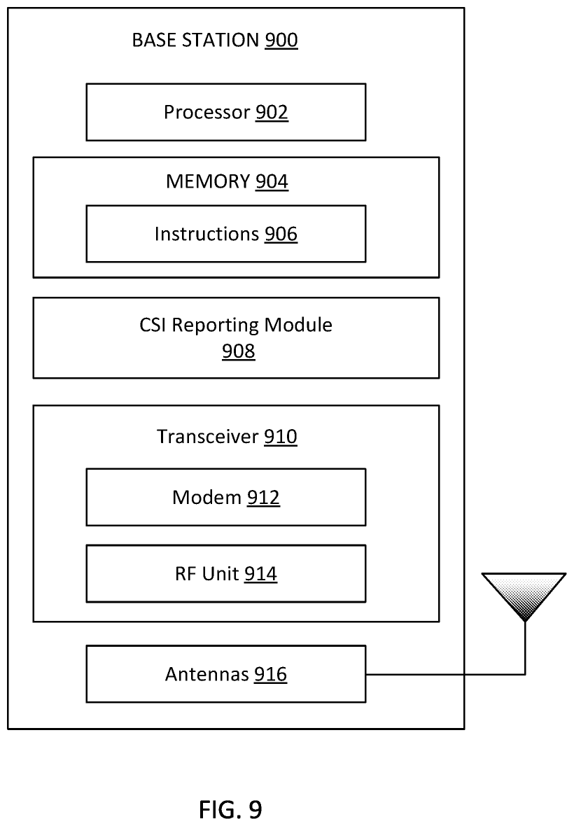

FIG. 9 is a block diagram of an exemplary BS 900 according to some aspects of the present disclosure. The BS 900 may be a BS 105 as discussed above. As shown, the BS 900 may include a processor 902, a memory 904, a CSI reporting module 908, a transceiver 910 including a modem subsystem 912 and a RF unit 914, and one or more antennas 916. These elements may be coupled with each other and in direct or indirect communication with each other, for example via one or more buses.

The processor 902 may have various features as a specific-type processor. For example, these may include a CPU, a DSP, an ASIC, a controller, a FPGA device, another hardware device, a firmware device, or any combination thereof configured to perform the operations described herein. The processor 902 may also be implemented as a combination of computing devices, e.g., a combination of a DSP and a microprocessor, a plurality of microprocessors, one or more microprocessors in conjunction with a DSP core, or any other such configuration.

The memory 904 may include a cache memory (e.g., a cache memory of the processor 902), RAM, MRAM, ROM, PROM, EPROM, EEPROM, flash memory, a solid state memory device, one or more hard disk drives, memristor-based arrays, other forms of volatile and non-volatile memory, or a combination of different types of memory. In some instances, the memory 904 may include a non-transitory computer-readable medium. The memory 904 may store instructions 906. The instructions 906 may include instructions that, when executed by the processor 902, cause the processor 902 to perform operations described herein, for example, aspects of FIGS. 2A, 2B, 3, 4, 5A, 5B, 6, 7, and 10-11. Instructions 906 may also be referred to as code, which may be interpreted broadly to include any type of computer-readable statement(s).

The CSI reporting module 908 may be implemented via hardware, software, or combinations thereof. For example, the CSI reporting module 908 may be implemented as a processor, circuit, and/or instructions 906 stored in the memory 904 and executed by the processor 902.

In some aspects, the CSI reporting module 908 may implement the aspects of FIGS. 2A, 2B, 3, 4, 5A, 5B, 6, 7, and 10-11. In some aspects, the CSI reporting module 908 may be configured to transmit a configuration for a CSI report setting to a UE (e.g., the UE 115 or 800). A report quantity configured by the CSI report setting may include measured channel characteristics of CSI-RS resources and/or SSB resources for channel measurement associated with the CSI report setting and parameters of predicted channel characteristics associated with the CSI-RS resources or the SSB resources for channel measurement associated with the CSI report setting. The CSI reporting module 908 may be configured to receive, from the UE, a CSI report based on the CSI report setting.

Additionally or alternatively, the CSI reporting module 908 can be implemented in any combination of hardware and software, and may, in some implementations, involve, for example, processor 902, memory 904, instructions 906, transceiver 910, and/or modem 912.

As shown, the transceiver 910 may include the modem subsystem 912 and the RF unit 914. The transceiver 910 can be configured to communicate bi-directionally with other devices, such as the UEs 115 and/or 800. The modem subsystem 912 may be configured to modulate and/or encode data according to a MCS, e.g., a LDPC coding scheme, a turbo coding scheme, a convolutional coding scheme, a digital beamforming scheme, etc. The RF unit 914 may be configured to process (e.g., perform analog to digital conversion or digital to analog conversion, etc.) modulated/encoded data from the modem subsystem 912 (on outbound transmissions) or of transmissions originating from another source such as a UE 115 or UE 800. The RF unit 914 may be further configured to perform analog beamforming in conjunction with the digital beamforming. Although shown as integrated together in transceiver 910, the modem subsystem 912 and/or the RF unit 914 may be separate devices that are coupled together at the BS 900 to enable the BS 900 to communicate with other devices.

The RF unit 914 may provide the modulated and/or processed data, e.g. data packets (or, more generally, data messages that may contain one or more data packets and other information), to the antennas 916 for transmission to one or more other devices. This may include, for example, a configuration indicating a plurality of sub-slots within a slot according to aspects of the present disclosure. The antennas 916 may further receive data messages transmitted from other devices and provide the received data messages for processing and/or demodulation at the transceiver 910. The antennas 916 may include multiple antennas of similar or different designs in order to sustain multiple transmission links.

In some instances, the BS 900 can include multiple transceivers 910 implementing different RATs (e.g., NR and LTE). In some instances, the BS 900 can include a single transceiver 910 implementing multiple RATs (e.g., NR and LTE). In some instances, the transceiver 910 can include various components, where different combinations of components can implement RATs.

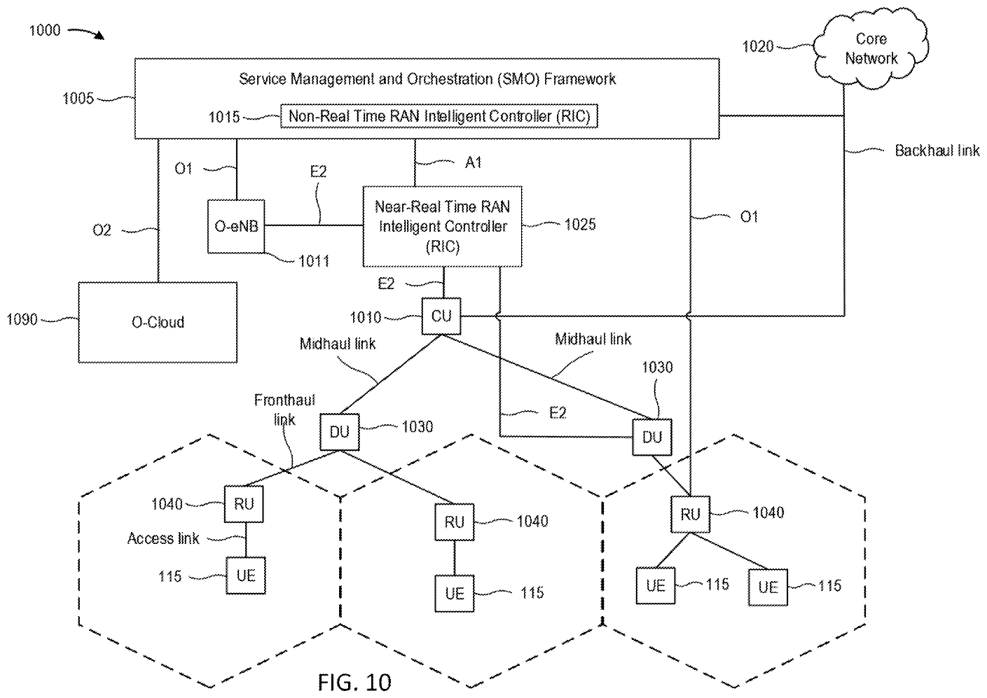

FIG. 10 shows a diagram illustrating an example disaggregated base station 1000 architecture. The disaggregated base station 1000 architecture may include one or more central units (CUs) 1010 that can communicate directly with a core network 1020 via a backhaul link, or indirectly with the core network 1020 through one or more disaggregated base station units (such as a Near-Real Time (Near-RT) RAN Intelligent Controller (RIC) 1025 via an E2 link, or a Non-Real Time (Non-RT) RIC 1015 associated with a Service Management and Orchestration (SMO) Framework X05, or both). A CU 1010 may communicate with one or more distributed units (DUs) 1030 via respective midhaul links, such as an F1 interface. The DUs 1030 may communicate with one or more radio units (RUs) 1040 via respective fronthaul links. The RUs 1040 may communicate with respective UEs 115 via one or more radio frequency (RF) access links. In some implementations, the UE 115 may be simultaneously served by multiple RUs 1040.

Each of the units, i.e., the CUS 1010, the DUs 1030, the RUs 1040, as well as the Near-RT RICs 1025, the Non-RT RICs 1015 and the SMO Framework 1005, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 1010 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 1010. The CU 1010 may be configured to handle user plane functionality (i.e., Central Unit-User Plane (CU-UP)), control plane functionality (i.e., Central Unit-Control Plane (CU-CP)), or a combination thereof. In some implementations, the CU 1010 can be logically split into one or more CU-UP units and one or more CU-CP units. The CU-UP unit can communicate bidirectionally with the CU-CP unit via an interface, such as the E1 interface when implemented in an O-RAN configuration. The CU 1010 can be implemented to communicate with the DU 1030, as necessary, for network control and signaling.

The DU 1030 may correspond to a logical unit that includes one or more base station functions to control the operation of one or more RUs 1040. In some aspects, the DU 1030 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 1030 may further host one or more low PHY layers. Each layer (or module) can be implemented with an interface configured to communicate signals with other layers (and modules) hosted by the DU 1030, or with the control functions hosted by the CU 1010.

Lower-layer functionality can be implemented by one or more RUs 1040. In some deployments, an RU 1040, controlled by a DU 1030, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 1040 can be implemented to handle over the air (OTA) communication with one or more UEs 115. In some implementations, real-time and non-real-time aspects of control and user plane communication with the RU(s) 1040 can be controlled by the corresponding DU 1030. In some scenarios, this configuration can enable the DU(s) 1030 and the CU 1010 to be implemented in a cloud-based RAN architecture, such as a vRAN architecture.

The SMO Framework 1005 may be configured to support RAN deployment and provisioning of non-virtualized and virtualized network elements. For non-virtualized network elements, the SMO Framework 1005 may be configured to support the deployment of dedicated physical resources for RAN coverage requirements which may be managed via an operations and maintenance interface (such as an O1 interface). For virtualized network elements, the SMO Framework 1005 may be configured to interact with a cloud computing platform (such as an open cloud (O-Cloud) 1090) to perform network element life cycle management (such as to instantiate virtualized network elements) via a cloud computing platform interface (such as an O2 interface). Such virtualized network elements can include, but are not limited to, CUs 1010, DUs 1030, RUs 1040 and Near-RT RICs 1025. In some implementations, the SMO Framework 1005 can communicate with a hardware aspect of a 4G RAN, such as an open eNB (O-eNB) 1011, via an O1 interface. Additionally, in some implementations, the SMO Framework 1005 can communicate directly with one or more RUs 1040 via an O1 interface. The SMO Framework 1005 also may include a Non-RT RIC 1015 configured to support functionality of the SMO Framework 1005.

The Non-RT RIC 1015 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 1025. The Non-RT RIC 1015 may be coupled to or communicate with (such as via an A1 interface) the Near-RT RIC 1025. The Near-RT RIC 1025 may be configured to include a logical function that enables near-real-time control and optimization of RAN elements and resources via data collection and actions over an interface (such as via an E2 interface) connecting one or more CUs 1010, one or more DUs 1030, or both, as well as an O-eNB, with the Near-RT RIC 1025.

In some implementations, to generate AI/ML models to be deployed in the Near-RT RIC 1025, the Non-RT RIC 1015 may receive parameters or external enrichment information from external servers. Such information may be utilized by the Near-RT RIC 1025 and may be received at the SMO Framework 1005 or the Non-RT RIC 1015 from non-network data sources or from network functions. In some examples, the Non-RT RIC 1015 or the Near-RT RIC 1025 may be configured to tune RAN behavior or performance. For example, the Non-RT RIC 1015 may monitor long-term trends and patterns for performance and employ AI/ML models to perform corrective actions through the SMO Framework 1005 (such as reconfiguration via 01) or via creation of RAN management policies (such as A1 policies).

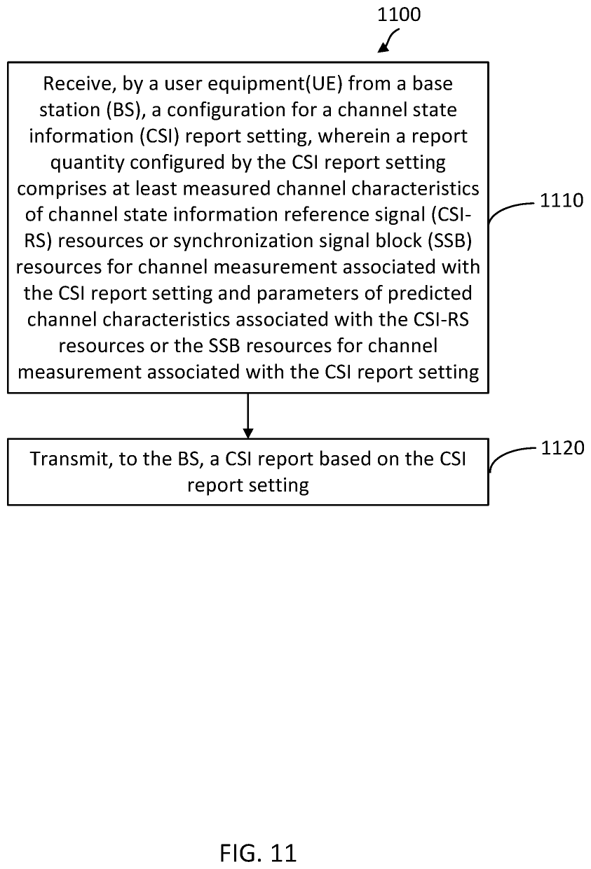

FIG. 11 is a flow diagram of a communication method 1100 according to some aspects of the present disclosure. Aspects of the method 1100 can be executed by a computing device (e.g., a processor, processing circuit, and/or other suitable component) of a wireless communication device or other suitable means for performing the aspects. For example, a wireless communication device, such as the UE 115 or UE 800, may utilize one or more components, such as the processor 802, the memory 804, the CSI reporting module 808, the transceiver 810, the modem 812, and the one or more antennas 816, to execute aspects of method 1100. The method 1100 may employ similar mechanisms as in the networks 100, 200, 205, and 1000 and the aspects and actions described with respect to FIGS. 2A, 2B, 3, 4, 5A, 5B, 6, and 7. As illustrated, the method 1100 includes a number of enumerated aspects, but the method 1100 may include additional aspects before, after, and in between the enumerated aspects. In some aspects, one or more of the enumerated aspects may be omitted or performed in a different order.

At action 1110, the method 1100 includes a UE (e.g., the UE 115 or the UE 800) receiving, from a BS (e.g., the BS 105 or 900), a configuration for a channel state information (CSI) report setting. In this regard, the UE may receive the configuration for the CSI report setting via a radio resource control (RRC) message, downlink control information (DCI), or other suitable control message. The configuration for the CSI report setting may include measured channel characteristics of channel state information reference signal (CSI-RS) resources and/or synchronization signal block (SSB) resources for channel measurement associated with the CSI report setting. The configuration for the CSI report setting may include, without limitation, a periodicity associated with transmitting the CSI report, the measured parameters to be included in the CSI report (e.g., SSBRI, CRI, SSB RSRP/SINR, CSI-RS RSRP/SINR, CQI, PMI, LI, RI), the predicted parameters to be included in the CSI report (e.g., strongest SSBRI(s)/CRI(s), ordering of the strongest SSBRI(s)/CRI(s), SSB RSRP/SINR, CSI-RS RSRP/SINR, probability/mean/variance of the strongest SSBRI(s)/CRI(s), CQI, PMI, LI, RI), the format of the CSI report (single-part fixed payload, two-part fixed/variable payload), priorities associated with the predicted parameters, the physical channel(s) to carry the CSI report (e.g., PUCCH, PUSCH), and/or other information regarding the content and/or transmission of the CSI report.

In some aspects, the BS may sweep a set of transmission beams (e.g., a first transmission beam, a second transmission beam, a third transmission beam, etc.) across a communication link according to a beam sweep pattern. The beam sweeping pattern may include transmitting a set of SSBs across the set of transmission beams. The BS may transmit an indication of the beam sweep pattern to the UE. The UE may perform measurements upon the SSBs received across the beams and transmit a CSI report to the BS indicating measurements associated with the beams. For example, the report may indicate a strongest beam of the set of transmission beams. The UE and the BS may establish communications over the communication link based on the CSI report. For example, the BS and the UE may perform an SSB beam sweep and CSI report procedure during an initial access procedure (e.g., as part of a random access channel (RACH) procedure). In some instances, beams used for SSB beam sweeping may include wide beams (e.g., layer 1 (L1) beams).

The BS may transmit a reference signal (e.g., a cell-specific reference signal (CRS-RS) or other suitable reference signal), which may be precoded or unprecoded. The UE may provide feedback for beam selection based on measurements of the received reference signal and/or predicted beam parameters associated with a future time period. In some instances, the feedback from the UE may be a precoding matrix indicator (PMI) or codebook-based feedback (e.g., a multi-panel type codebook, a linear combination type codebook, a port selection type codebook). In some aspects, the beam sweeping pattern may include transmitting a set of CSI-RSs across the set of transmission beams The BS may transmit an indication of the beam sweep pattern to the UE. The UE may perform CSI measurements on the CSI-RSs received across the beams and transmit a CSI report to the BS indicating channel state information. For example, the CSI report may indicate a strongest beam of the set of transmission beams. The UE and the BS may maintain or update communications over the communication link based on the CSI report. For example, the BS and the UE may periodically perform a CSI-RS beam sweep and CSI report procedure while in an RRC connected mode. In some aspects, the BS and the UE may perform a CSI-RS beam sweep and CSI report procedure as part of a beam failure recovery procedure (e.g., to facilitate recovery) or a radio link failure procedure (e.g., as a procedure to re-establish communications).

The CSI-RS beam sweep may be a P1, P2, and/or P3 procedure. P1 may be a beam selection procedure where the BS sweeps the beam and the UE selects the strongest beam and reports the strongest beam to the BS. P2 may be a beam refinement procedure for the BS, where the BS may refine a beam (e.g., via sweeping a narrower beam over a narrower range), and the UE may detect and report the strongest beam (e.g., from the set of narrower beams) to the BS. P3 may be a beam refinement procedure for the UE, where the BS may fix a beam (e.g., transmit the same beam repeatedly), and the UE may refine its receiver to optimize receipt of the fixed beam. The BS and the UE may perform similar processes, but in reverse, for uplink beam management (e.g., U1, U2, and/or U3 procedures).

In some aspects, the UE may report an SSB resource block indicator (SSBRI), a CSI-RS resource indicator (CRI), a layer 1 reference signal received power (RSRP) associated with the CSI-RS resources, and/or a signal-to-noise and interference ratio (SINR) associated with the CSI-RS resources via the CSI report. The UE may receive from the BS a report quantity message indicating which parameters (e.g., SSB RSRP/SINR, CSI-RS RSRP/SINR, CQI, PMI, RI, etc.) should be measured and reported via the CSI report. For example, the CSI report configuration for the UE may include the fields ReportQuantity=ssb-Index-RSRP, ssb-Index-SINR, cri-RSRP, and/or cri-SINR for joint SSBRI/CRI and L1-RSRP/L1-SINR beam reporting. The UE may report a number of different SSBRIs or CRIs for each CSI report configuration, where the number may be equal to the number of reported reference signals. The number of reported reference signals may be configured via RRC messaging.

In some aspects, the configuration for the CSI report setting may indicate that the CSI report may include parameters of predicted channel characteristics associated with the CSI-RS resources and/or the SSB resources. In some aspects, the UE may be configured to transmit a CSI report periodically (e.g., every 20 ms, 40 ms, 80 ms, etc.). Frequent beam management and transmission of CSI reports (e.g., every 20 ms or 40 ms) may consume UE overhead and/or UE power. In stationary or low mobility UE scenarios, the strongest beam index may not change frequently (e.g., may not change over hundreds of ms, seconds, minutes, or even longer periods of time), therefore the UE may reduce overhead and/or power consumption by predicting a strongest beam change at the UE and transmitting a CSI report less frequently and/or on request from the BS. In some aspects, the UE may use an artificial intelligence based beam prediction technique that may rely on parameters of predicted channel characteristics associated with the CSI-RS resources and/or the SSB resources. For example, the UE may use a convolutional neural network (CNN), a recurrent neural network (RNN), a long short-term memory (LSTM), or the like for predicting parameters of channel characteristics, including without limitation the strongest beam index.

In some instances, the UE may predict whether the strongest beam index may change (or change more frequently and/or dynamically) at a future time (or in a future time window). The UE may predict the changes in the strongest beam index using measurements obtained based on a beam management periodicity. In some instances, the UE may utilize a beam management periodicity that is longer than a default beam management periodicity (e.g., 20 or 40 ms). In some instances, the beam management periodicity may be greater than 100 ms, including without limitation 200 ms, 300 ms, 400 ms, 500 ms, and/or any other suitable periodicity.

In some aspects, the UE may reduce overhead by omitting certain reporting quantities (e.g., predicted parameters) from the CSI report (e.g., intra-report omission). For example, the predicted parameters may be associated with different priorities. The priorities may determine whether the parameters will be included in the CSI report. The UE may determine the priorities associated with the predicted parameters and/or the UE may receive a message from the BS via RRC messaging indicating the priorities. The priorities associated with the predicted parameters may be based on a level of influence the parameter may have on predicting whether the strongest beam may change at a future time period. For example, a predicted RSRP mean may have a higher priority than a predicted RSRP variance. A predicted strongest beam index may have a higher priority than a predicted RSRP value. A predicted strongest beam change instance at a future time may have a higher priority than a predicted non-changing strongest beam at a future time. When the PUSCH and/or PUCCH resources are limited, one or more predicted parameters may be omitted from the CSI report based on their associated priorities in order to conserve resources.

At action 1120, the UE may transmit the CSI report to the BS based on the CSI report setting. In this regard, the UE may transmit the CSI report to the BS using any suitable channel(s). For example, the UE may transmit the measured parameters and the predicted parameters in a single-part payload and/or a two-part payload via a physical uplink shared channel (PUSCH). In some aspects, the UE may transmit the measured parameters in a first part of a two-part payload via a physical uplink control channel (PUCCH) while the predicted parameters are transmitted via a second part of the two-part payload via a PUSCH. In this case, the PUCCH may include a scheduling request for transmitting the second part via the PUSCH. In some aspects, the UE may transmit the measured parameters and the predicted parameters in a single-part payload and/or a two-part payload via a PUCCH. For example, the UE may transmit the measured parameters (e.g., SSB RSRP/SINR, CSI-RS RSRP/SINR, CQI, PMI, LI, RI, etc.) and the predicted parameters (e.g., strongest SSBRI(s)/CRI(s), ordering of the strongest SSBRI(s)/CRI(s), SSB RSRP/SINR, CSI-RS RSRP/SINR, probability/mean/variance of the strongest SSBRI(s)/CRI(s) CQI, PMI, RI, etc.) in a single-part payload via a PUCCH. The UE may transmit the measured parameters (e.g., SSB RSRP/SINR, CSI-RS RSRP/SINR, CQI, PMI, LI, RI, etc.) in the first part of the two-part payload via a PUCCH and transmit the predicted parameters (e.g., strongest SSBRI(s)/CRI(s), ordering of the strongest SSBRI(s)/CRI(s), SSB RSRP/SINR, CSI-RS RSRP/SINR, probability/mean/variance of the strongest SSBRI(s)/CRI(s) CQI, PMI, RI, etc.) in the second part of the two-part payload via a PUCCH.

The UE may transmit the CSI report to the BS based on a periodic basis or a semi-persistent basis. In this regard, the UE may receive an indicator from the BS via RRC messaging indicating the periodicity at which the UE may transmit the CSI report. In some aspects, the UE may receive a request from the BS requesting a CSI report. The UE may transmit the CSI report to the BS in response to the request.

In some instances, the UE may utilize less than all available CSI-RS or SSB resources to predict a strongest beam index and/or a change in the strongest beam index. For example, the UE may utilize a subset of measured beams (e.g., 2, 3, 4, 5, 6, 7, 8, etc.) to predict a strongest beam from a larger set of potential beams (e.g., 12, 16, 18, 20, 24, 32, 64, etc.). In some aspects, the UE may report to the BS its level of capability in predicting parameters associated with the CSI-RS resources or the SSB resources. In this regard, the UE may transmit a capability message indicating whether the UE supports prediction based beam management. The UE may transmit the capability message during an RRC connection setup procedure. The capability message may include which parameters the UE is capable of predicting.

In some aspects, the configuration for the CSI report setting may indicate that the CSI report may include an indicator indicating whether a reference signal received power (RSRP) and/or a signal-to-noise and interference ratio (SINR) of the predicted channel characteristics is stronger than a RSRP of the measured channel characteristics. For example, the UE may predict the RSRP/SINR of an SSB and/or a CSI-RS at a future time. The UE may compare the predicted RSRP/SINR to a measured RSRP/SINR of an SSB and/or CSI-RS (e.g., measured over one or more time periods) and determine if the predicted RSRP/SINR is stronger (e.g., higher) than the measured RSRP/SINR. If the predicted RSRP/SINR is stronger than the measured RSRP/SINR, the UE may indicate such in the CSI report. In some aspects, the UE may indicate an index associated with the predicted strongest SSB and/or strongest CSI-RS in the CSI report. In some aspects, the UE may predict the RSRP/SINR of a set of SSBs and/or a set of CSI-RSs at a future time. The set of SSBs and/or the set of CSI-RSs may be associated with a set of beams (e.g., a set of adjacent and/or partially overlapping beams). The UE may predict the RSRP/SINR of each SSB of the set of SSBs and/or each CSI-RS of the set of CSI-RSs. The UE may order the set of SSBs and/or the set of CSI-RSs based on their predicted RSRP/SINR. The UE may order the set of SSBs and/or the set of CSI-RSs based on a decreasing value of their predicted RSRP/SINR (e.g., highest RSRP/SINR ranked first, next highest RSRP/SINR ranked second, etc.). The UE may report the ordered set of predicted RSRP/SINR of each SSB of the set of SSBs and/or each CSI-RS of the set of CSI-RSs. In some aspects, the UE may report the ordered set of predicted RSRP/SINR of a subset of SSBs (e.g., highest 3 SSBs) of the set of SSBs and/or a subset of CSI-RSs (e.g., highest 3 CSI-RSs) of the set of CSI-RSs. The UE may report the indexes associated with the ordered set of predicted RSRP/SINRs and/or the values (e.g., dBm values) of the ordered set of predicted RSRP/SINRs in the CSI report.

In some aspects, the configuration for the CSI report setting may indicate that the CSI report may include prediction probabilities associated with one or more of the predicted parameters. For example, the UE may predict the RSRPs/SINRs associated with the beams at a future time using an artificial intelligence (AI) algorithm (e.g., a softmax model). The AI algorithm may produce a probability associated with the predicted RSRPs/SINRs. The probability may be a confidence score that indicates a level of confidence associated with the predicted RSRPs/SINRs. The probability may be represented as a value between 0 and 1 where a higher value indicates a higher level of confidence in the predicted RSRPs/SINRs.

In some aspects, the configuration for the CSI report setting may indicate that the CSI report may include a mean (e.g., an average) associated with one or more of the predicted channel characteristics. For example, the UE may predict the RSRPs/SINRs associated with the beams at a future time. The UE may determine a mean value of the predicted RSRPs/SINRs for a set of beams by summing all the RSRPs/SINRs values and dividing by the number of values. In some aspects, the UE may predict a number of values of the RSRPs/SINRs associated with a set of beams over a future time period and average those values over the time period.

In some aspects, the configuration for the CSI report setting may indicate that the CSI report may include a variance associated with one or more of the predicted parameters. For example, the UE may predict the RSRPs/SINRs associated with the beams at a future time using an AI algorithm (e.g., an AI model). The variance may be the variability in the AI algorithm prediction. The UE may determine a variance of the predicted RSRPs/SINRs for a set of beams and report the variance in the CSI report.

In some aspects, the configuration for the CSI report setting may indicate that the CSI report may include a precoding matrix indicator (PMI) associated with one or more of the predicted parameters. For example, the UE may predict the PMI associated with the beams at a future time. In this regard, the CSI report may include a predicted PMI and/or codebook-based indicator (e.g., a multi-panel type codebook, a linear combination type codebook, a port selection type codebook) associated with the beams at a future time.

In some aspects, the configuration for the CSI report setting may indicate that the CSI report may include a rank indicator (RI) associated with one or more of the predicted parameters. For example, the UE may predict the RI associated with the beams at a future time. The UE may determine the correlation between the different signals received at each receive antenna of the UE. The best performance may occur when signals are not correlated between the beams. The correlation may indicate a level of interference between the beams. The number of useful layers may depend upon a corresponding high number of uncorrelated propagation paths between the beams. The CSI report may include a predicted RI associated with the beams at a future time.

In some aspects, the configuration for the CSI report setting may indicate that the CSI report may include a layer indicator (LI) associated with one or more of the predicted parameters. For example, the UE may predict the LI associated with the beams at a future time. The LI may identify the strongest layer from the set of layers indicated by the predicted RI.

In some aspects, the configuration for the CSI report setting may indicate that the CSI report may include a channel quality indicator (CQI) associated with one or more of the predicted parameters. For example, the UE may predict the CQI associated with the beams at a future time. In this regard, the CQI may indicate the highest modulation scheme and the coding rate (MCS) suitable for downlink transmissions to achieve a certain block error rate (BLER) associated with the beams at a future time.

In some aspects, the CSI report may include a single-part payload. The single-part payload may include the measured channel characteristics and/or the parameters of the predicted channel characteristics. In this regard, the single-part payload may include a fixed size payload having a number of code points (e.g., 128 code points). For example, in L1 RSRP reporting, for the strongest SSBRI, 7 bits may be used to report the RSRP in the range of −140 dBm to −44 dBm with a 1 dBm step size. For the remaining SSBRIs or CRIs, 4 bits may be used to report a differential RSRP in the range of 0 dB to −30 dB with a 2 dB step size and a reference to the strongest SSBRI or CRI's L1 RSRP. For the strongest SSBRI or CRI's L1 RSRP, there are 31 invalid code points (128-97) since 2\hat{ }7=128 code points are available in the 7 bits, but only 140−44+1=97 code points are the valid code points. In some aspects, the number of code points considered valid or invalid may be based on a level of standards (e.g., 3GPP standards) compliance of the UE and/or the BS.

In some aspects, the single-part payload may include both the measured channel characteristics and the predicted parameters being carried in any suitable combination of fixed code points. For example, the measured channel characteristics and the predicted parameters may be carried by the valid code points of the single-part payload, the measured channel characteristics may be carried by the valid code points while the predicted parameters may be carried by the invalid code points, and/or the measured channel characteristics and the predicted parameters may be carried by the invalid code points of the single-part payload.

In some aspects, the CSI report comprising a single-part payload may include measured parameters such as the SSB-index-RSRP of a set of the strongest SSBRIs (e.g., the four strongest SSBRIs) and the predicted parameters. The predicted parameters may include an indicator indicating the predicted strongest SSBRI will remain the same as the most recent measured strongest SSBRI for a period of time (e.g., 20 ms, 40 ms, 80 ms, or more). The CSI report may include the period of time over which the predicted strongest SSBRI will remain the same as the most recent measured strongest SSBRI. In some aspects, the predicted parameters may include an indicator indicating the predicted strongest SSBRI will change at a future point in time. The future point in time may be relative to the time of the most recently received SSBs. The CSI report may include an indicator indicating when the predicted strongest SSBRI will change, the SSBRI that the strongest SSBRI will change to, a probability associated with the predicted strongest SSBRI, an RSRP associated with the SSBRI that the strongest SSBRI will change to, a predicted mean of the RSRP associated with the SSBRI that the strongest SSBRI will change to, and/or a predicted variance of the RSRP associated with the SSBRI that the strongest SSBRI will change to.

In some aspects, the CSI report may comprise a two-part payload. The two-part payload may include a first part having a fixed payload size and a second part having a payload size based on at least one of the measured channel characteristics included in the first part or the parameters of the predicted channel characteristics included in the first part. In some aspects, the first part may include the measured channel characteristics while the second part includes the predicted parameters. The first part may include an indicator indicating which predicted parameter quantities (e.g., strongest SSBRI(s)/CRI(s), probability, mean, variance, PMI, RI, LI, CQI, etc.) are included in the second part. The first part of the two-part payload may also indicate the size of the second part of the two-part payload. The UE may receive a configuration from the BS via a RRC message indicating the predicted parameter quantities to be included in the second part. The payload size of the second part may be variable and based on the predicted parameter quantities to be included in the second part. In some aspects, the second part may be compressed using a lossless data compression algorithm to reduce the size of the second part payload. In some aspects, the size of the second part payload may be reduced by a differential reporting method where the predicted parameters are reported as a differential to a previous second part CSI report.

In some aspects, the first part may include the measured channel characteristics and a first portion of the predicted parameters while the second part includes a second portion (e.g., a remaining portion) of the predicted parameters. For example, the first part of the two-part payload may include an indicator that the strongest SSBRI will change at a future time while the second part includes the time when the strongest SSBRI will change and/or the RSRP of the predicted strongest SSBRI.

In some aspects, the first part of the CSI report may include an indicator indicating the CSI report comprises only the first part. In this regard, the UE may only transmit the first part of the two-part payload to the BS further reducing overhead and resources. The indicator indicating the CSI report comprises only the first part may indicate to the BS that the strongest SSBRI/CRI will remain the same before the next CSI reporting period. The UE may continue to include only the first part in the CSI report for each reporting period until the UE predicts that the strongest SSBRI/CRI will change.

In some aspects, predetermined code points in the CSI report may indicate the single-part, fixed-payload CSI report includes the predicted parameters. In this regard, the UE may receive an indicator from the BS via an RRC message indicating the predetermined code points that indicate the CSI report includes the predicted parameters. For example, a set of predetermined L1-RSRP/SINR code points may indicate that the predicted parameter quantities are included in the CSI report. The set of predetermined L1-RSRP/SINR code points may include invalid code points for the strongest SSBRI/CRI's L1-RSRP. As another example, a predetermined code point (e.g., a single bit) in the CSI report may indicate the CSI report includes the predicted parameters.

In some aspect, the UE may indicate an invalid RSRP of a beam in the CSI report to indicate to the BS to reinterpret the single-part, fixed-payload CSI report. For example, the UE may indicate via a predetermined code point and/or an invalid RSRP of a beam to the BS to interpret the quantities in the CSI report as predicted parameters rather than measured parameters. Different predetermined code points may indicate different predicted parameters are included in the CSI report.

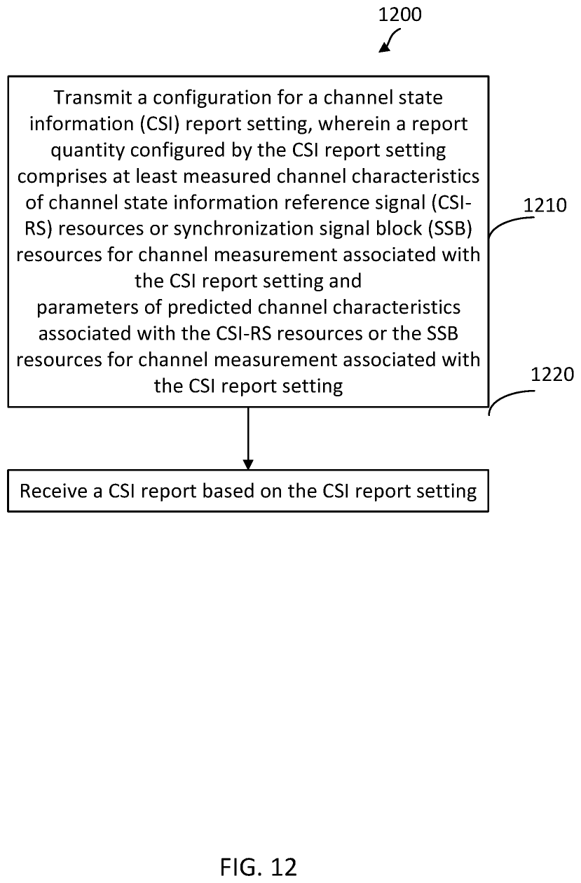

FIG. 12 is a flow diagram of a communication method 1200 according to some aspects of the present disclosure. Aspects of the method 1200 can be executed by a computing device (e.g., a processor, processing circuit, and/or other suitable component) of a wireless communication device or other suitable means for performing the aspects. For example, a wireless communication device, such as the BS 105, RU 240, or BS 900, may utilize one or more components, such as the processor 902, the memory 904, the CSI reporting module 908, the transceiver 910, the modem 912, and the one or more antennas 916, to execute aspects of method 1200. The method 1200 may employ similar mechanisms as in the networks 100, 200, 205, and 1000 and the aspects and actions described with respect to FIGS. 2A, 2B, 3, 4, 5A, 5B, 6, and 7. As illustrated, the method 1200 includes a number of enumerated aspects, but the method 1200 may include additional aspects before, after, and in between the enumerated aspects. In some aspects, one or more of the enumerated aspects may be omitted or performed in a different order.

At action 1210, the method 1200 includes a BS (e.g., the BS 105 or the BS 900) or RU transmitting, to a UE (e.g., the UE 115 or 800), a configuration for a channel state information (CSI) report setting. In this regard, the BS may transmit the configuration for the CSI report setting via a radio resource control (RRC) message, downlink control information (DCI), or other suitable control message. The configuration for the CSI report setting may include measured channel characteristics of channel state information reference signal (CSI-RS) resources and/or synchronization signal block (SSB) resources for channel measurement associated with the CSI report setting. The configuration for the CSI report setting may include, without limitation, a periodicity associated with transmitting the CSI report, the measured parameters to be included in the CSI report (e.g., SSBRI, CRI, SSB RSRP/SINR, CSI-RS RSRP/SINR, CQI, PMI, LI, RI), the predicted parameters to be included in the CSI report (e.g., strongest SSBRI(s)/CRI(s), ordering of the strongest SSBRI(s)/CRI(s), SSB RSRP/SINR, CSI-RS RSRP/SINR, probability/mean/variance of the strongest SSBRI(s)/CRI(s), CQI, PMI, LI, RI), the format of the CSI report (single-part fixed payload, two-part fixed/variable payload), priorities associated with the predicted parameters, the physical channel(s) to carry the CSI report (e.g., PUCCH, PUSCH), and/or other information regarding the content and/or transmission of the CSI report.

In some aspects, the BS may sweep a set of transmission beams (e.g., a first transmission beam, a second transmission beam, a third transmission beam, etc.) across a communication link according to a beam sweep pattern. The beam sweeping pattern may include transmitting a set of SSBs across the set of transmission beams. The BS may transmit an indication of the beam sweep pattern to the UE. The UE may perform measurements upon the SSBs received across the beams and transmit a CSI report to the BS indicating measurements associated with the beams. For example, the report may indicate a strongest beam of the set of transmission beams. The UE and the BS may establish communications over the communication link based on the CSI report. For example, the BS and the UE may perform an SSB beam sweep and CSI report procedure during an initial access procedure (e.g., as part of a random access channel (RACH) procedure). In some instances, beams used for SSB beam sweeping may include wide beams (e.g., layer 1 (L1) beams).

The BS may transmit a reference signal (e.g., a cell-specific reference signal (CRS-RS) or other suitable reference signal), which may be precoded or unprecoded. The UE may provide feedback for beam selection based on measurements of the received reference signal and/or predicted beam parameters associated with a future time period. In some instances, the feedback from the UE may be a precoding matrix indicator (PMI) or codebook-based feedback (e.g., a multi-panel type codebook, a linear combination type codebook, a port selection type codebook). In some aspects, the beam sweeping pattern may include transmitting a set of CSI-RSs across the set of transmission beams The BS may transmit an indication of the beam sweep pattern to the UE. The UE may perform CSI measurements on the CSI-RSs received across the beams and transmit a CSI report to the BS indicating channel state information. For example, the CSI report may indicate a strongest beam of the set of transmission beams. The UE and the BS may maintain or update communications over the communication link based on the CSI report. For example, the BS and the UE may periodically perform a CSI-RS beam sweep and CSI report procedure while in an RRC connected mode. In some aspects, the BS and the UE may perform a CSI-RS beam sweep and CSI report procedure as part of a beam failure recovery procedure (e.g., to facilitate recovery) or a radio link failure procedure (e.g., as a procedure to re-establish communications).

The CSI-RS beam sweep may be a P1, P2, and/or P3 procedure. P1 may be a beam selection procedure where the BS sweeps the beam and the UE selects the strongest beam and reports the strongest beam to the BS. P2 may be a beam refinement procedure for the BS, where the BS may refine a beam (e.g., via sweeping a narrower beam over a narrower range), and the UE may detect and report the strongest beam (e.g., from the set of narrower beams) to the BS. P3 may be a beam refinement procedure for the UE, where the BS may fix a beam (e.g., transmit the same beam repeatedly), and the UE may refine its receiver to optimize receipt of the fixed beam. The BS and the UE may perform similar processes, but in reverse, for uplink beam management (e.g., U1, U2, and/or U3 procedures).

In some aspects, the BS may receive from the UE a report including an SSB resource block indicator (SSBRI), a CSI-RS resource indicator (CRI), a layer 1 reference signal received power (RSRP) associated with the CSI-RS resources, and/or a signal-to-noise and interference ratio (SINR) associated with the CSI-RS resources via the CSI report. The BS may transmit to the UE a report quantity message indicating which parameters (e.g., SSB RSRP/SINR, CSI-RS RSRP/SINR, CQI, PMI, RI, etc.) should be measured and reported via the CSI report. For example, the CSI report configuration for the UE may include the fields ReportQuantity=ssb-Index-RSRP, ssb-Index-SINR, cri-RSRP, and/or cri-SINR for joint SSBRI/CRI and L1-RSRP/L1-SINR beam reporting. The UE may report a number of different SSBRIs or CRIs for each CSI report configuration, where the number may be equal to the number of reported reference signals. The number of reported reference signals may be configured via RRC messaging.

In some aspects, the configuration for the CSI report setting may indicate that the CSI report may include parameters of predicted channel characteristics associated with the CSI-RS resources and/or the SSB resources. In some aspects, the BS may be configured to receive a CSI report periodically (e.g., every 20 ms, 40 ms, 80 ms, etc.). Frequent beam management and transmission of CSI reports (e.g., every 20 ms or 40 ms) may consume UE overhead and/or UE power. In stationary or low mobility UE scenarios, the strongest beam index may not change frequently (e.g., may not change over hundreds of ms, seconds, minutes, or even longer periods of time), therefore the UE may reduce overhead and/or power consumption by predicting a strongest beam change at the UE and transmitting a CSI report less frequently and/or on request from the BS. In some aspects, the UE may use an artificial intelligence based beam prediction technique that may rely on parameters of predicted channel characteristics associated with the CSI-RS resources and/or the SSB resources. For example, the UE may use a convolutional neural network (CNN), a recurrent neural network (RNN), a long short-term memory (LSTM), or the like for predicting parameters of channel characteristics, including without limitation the strongest beam index.

In some instances, the UE may predict whether the strongest beam index may change (or change more frequently and/or dynamically) at a future time (or in a future time window). The UE may predict the changes in the strongest beam index using measurements obtained based on a beam management periodicity. In some instances, the UE may utilize a beam management periodicity that is longer than a default beam management periodicity (e.g., 20 or 40 ms). In some instances, the beam management periodicity may be greater than 100 ms, including without limitation 200 ms, 300 ms, 400 ms, 500 ms, and/or any other suitable periodicity.

In some aspects, the UE may reduce overhead by omitting certain reporting quantities (e.g., predicted parameters) from the CSI report (e.g., intra-report omission). For example, the predicted parameters may be associated with different priorities. The priorities may determine whether the parameters will be included in the CSI report. The UE may determine the priorities associated with the predicted parameters and/or the BS may transmit a message to the UE via RRC messaging indicating the priorities. The priorities associated with the predicted parameters may be based on a level of influence the parameter may have on predicting whether the strongest beam may change at a future time period. For example, a predicted RSRP mean may have a higher priority than a predicted RSRP variance. A predicted strongest beam index may have a higher priority than a predicted RSRP value. A predicted strongest beam change instance at a future time may have a higher priority than a predicted non-changing strongest beam at a future time. When the PUSCH and/or PUCCH resources are limited, one or more predicted parameters may be omitted from the CSI report based on their associated priorities in order to conserve resources.

At action 1220, the BS may receive the CSI report from the UE based on the CSI report setting. In this regard, the BS may receive the CSI report from the UE using any suitable channel(s). For example, the BS may receive the measured parameters and the predicted parameters in a single-part payload and/or a two-part payload via a physical uplink shared channel (PUSCH). In some aspects, the BS may receive the measured parameters in a first part of a two-part payload via a physical uplink control channel (PUCCH) while the predicted parameters are transmitted via a second part of the two-part payload via a PUSCH. In this case, the PUCCH may include a scheduling request for transmitting the second part via the PUSCH. In some aspects, the BS may receive the measured parameters and the predicted parameters in a single-part payload and/or a two-part payload via a PUCCH. For example, the BS may receive the measured parameters (e.g., SSB RSRP/SINR, CSI-RS RSRP/SINR, CQI, PMI, LI, RI, etc.) and the predicted parameters (e.g., strongest SSBRI(s)/CRI(s), ordering of the strongest SSBRI(s)/CRI(s), SSB RSRP/SINR, CSI-RS RSRP/SINR, probability/mean/variance of the strongest SSBRI(s)/CRI(s) CQI, PMI, RI, etc.) in a single-part payload via a PUCCH. The BS may receive the measured parameters (e.g., SSB RSRP/SINR, CSI-RS RSRP/SINR, CQI, PMI, LI, RI, etc.) in the first part of the two-part payload via a PUCCH and receive the predicted parameters (e.g., strongest SSBRI(s)/CRI(s), ordering of the strongest SSBRI(s)/CRI(s), SSB RSRP/SINR, CSI-RS RSRP/SINR, probability/mean/variance of the strongest SSBRI(s)/CRI(s) CQI, PMI, RI, etc.) in the second part of the two-part payload via a PUCCH.

The BS may receive the CSI report from the UE based on a periodic basis or a semi-persistent basis. In this regard, the BS may transmit receive an indicator to the UE via RRC messaging indicating the periodicity at which the UE may transmit the CSI report. In some aspects, the BS may transmit a request to the UE requesting a CSI report. The BS may receive the CSI report from the UE in response to the request.

In some instances, the UE may utilize less than all available CSI-RS or SSB resources to predict a strongest beam index and/or a change in the strongest beam index. For example, the UE may utilize a subset of measured beams (e.g., 2, 3, 4, 5, 6, 7, 8, etc.) to predict a strongest beam from a larger set of potential beams (e.g., 12, 16, 18, 20, 24, 32, 64, etc.). In some aspects, the UE may report to the BS its level of capability in predicting parameters associated with the CSI-RS resources or the SSB resources. In this regard, the BS may receive a capability message indicating whether the UE supports prediction based beam management. The BS may receive the capability message during an RRC connection setup procedure. The capability message may include which parameters the UE is capable of predicting.

In some aspects, the configuration for the CSI report setting may indicate that the CSI report may include an indicator indicating whether a reference signal received power (RSRP) and/or a signal-to-noise and interference ratio (SINR) of the predicted channel characteristics is stronger than a RSRP of the measured channel characteristics. For example, the UE may predict the RSRP/SINR of an SSB and/or a CSI-RS at a future time. The UE may compare the predicted RSRP/SINR to a measured RSRP/SINR of an SSB and/or CSI-RS (e.g., measured over one or more time periods) and determine if the predicted RSRP/SINR is stronger (e.g., higher) than the measured RSRP/SINR. If the predicted RSRP/SINR is stronger than the measured RSRP/SINR, the UE may indicate such in the CSI report. In some aspects, the UE may indicate an index associated with the predicted strongest SSB and/or strongest CSI-RS in the CSI report. In some aspects, the UE may predict the RSRP/SINR of a set of SSBs and/or a set of CSI-RSs at a future time. The set of SSBs and/or the set of CSI-RSs may be associated with a set of beams (e.g., a set of adjacent and/or partially overlapping beams). The UE may predict the RSRP/SINR of each SSB of the set of SSBs and/or each CSI-RS of the set of CSI-RSs. The UE may order the set of SSBs and/or the set of CSI-RSs based on their predicted RSRP/SINR. The UE may order the set of SSBs and/or the set of CSI-RSs based on a decreasing value of their predicted RSRP/SINR (e.g., highest RSRP/SINR ranked first, next highest RSRP/SINR ranked second, etc.). The UE may report the ordered set of predicted RSRP/SINR of each SSB of the set of SSBs and/or each CSI-RS of the set of CSI-RSs. In some aspects, the UE may report the ordered set of predicted RSRP/SINR of a subset of SSBs (e.g., highest 3 SSBs) of the set of SSBs and/or a subset of CSI-RSs (e.g., highest 3 CSI-RSs) of the set of CSI-RSs. The UE may report the indexes associated with the ordered set of predicted RSRP/SINRs and/or the values (e.g., dBm values) of the ordered set of predicted RSRP/SINRs in the CSI report.

In some aspects, the configuration for the CSI report setting may indicate that the CSI report may include prediction probabilities associated with one or more of the predicted parameters. For example, the UE may predict the RSRPs/SINRs associated with the beams at a future time using an artificial intelligence (AI) algorithm (e.g., a softmax model). The AI algorithm may produce a probability associated with the predicted RSRPs/SINRs. The probability may be a confidence score that indicates a level of confidence associated with the predicted RSRPs/SINRs. The probability may be represented as a value between 0 and 1 where a higher value indicates a higher level of confidence in the predicted RSRPs/SINRs.

In some aspects, the configuration for the CSI report setting may indicate that the CSI report may include a mean (e.g., an average) associated with one or more of the predicted channel characteristics. For example, the UE may predict the RSRPs/SINRs associated with the beams at a future time. The UE may determine a mean value of the predicted RSRPs/SINRs for a set of beams by summing all the RSRPs/SINRs values and dividing by the number of values. In some aspects, the UE may predict a number of values of the RSRPs/SINRs associated with a set of beams over a future time period and average those values over the time period.

In some aspects, the configuration for the CSI report setting may indicate that the CSI report may include a variance associated with one or more of the predicted parameters. For example, the UE may predict the RSRPs/SINRs associated with the beams at a future time using an AI algorithm (e.g., an AI model). The variance may be the variability in the AI algorithm prediction. The UE may determine a variance of the predicted RSRPs/SINRs for a set of beams and report the variance in the CSI report.

In some aspects, the configuration for the CSI report setting may indicate that the CSI report may include a precoding matrix indicator (PMI) associated with one or more of the predicted parameters. For example, the UE may predict the PMI associated with the beams at a future time. In this regard, the CSI report may include a predicted PMI and/or codebook-based indicator (e.g., a multi-panel type codebook, a linear combination type codebook, a port selection type codebook) associated with the beams at a future time.

In some aspects, the configuration for the CSI report setting may indicate that the CSI report may include a rank indicator (RI) associated with one or more of the predicted parameters. For example, the UE may predict the RI associated with the beams at a future time. The UE may determine the correlation between the different signals received at each receive antenna of the UE. The best performance may occur when signals are not correlated between the beams. The correlation may indicate a level of interference between the beams. The number of useful layers may depend upon a corresponding high number of uncorrelated propagation paths between the beams. The CSI report may include a predicted RI associated with the beams at a future time.

In some aspects, the configuration for the CSI report setting may indicate that the CSI report may include a layer indicator (LI) associated with one or more of the predicted parameters. For example, the UE may predict the LI associated with the beams at a future time. The LI may identify the strongest layer from the set of layers indicated by the predicted RI.

In some aspects, the configuration for the CSI report setting may indicate that the CSI report may include a channel quality indicator (CQI) associated with one or more of the predicted parameters. For example, the UE may predict the CQI associated with the beams at a future time. In this regard, the CQI may indicate the highest modulation scheme and the coding rate (MCS) suitable for downlink transmissions to achieve a certain block error rate (BLER) associated with the beams at a future time.

In some aspects, the CSI report may include a single-part payload. The single-part payload may include the measured channel characteristics and/or the parameters of the predicted channel characteristics. In this regard, the single-part payload may include a fixed size payload having a number of code points (e.g., 128 code points). For example, in L1 RSRP reporting, for the strongest SSBRI, 7 bits may be used to report the RSRP in the range of −140 dBm to −44 dBm with a 1 dBm step size. For the remaining SSBRIs or CRIs, 4 bits may be used to report a differential RSRP in the range of 0 dB to −30 dB with a 2 dB step size and a reference to the strongest SSBRI or CRI's L1 RSRP. For the strongest SSBRI or CRI's L1 RSRP, there are 31 invalid code points (128-97) since 2\hat{ }7=128 code points are available in the 7 bits, but only 140−44+1=97 code points are the valid code points. In some aspects, the number of code points considered valid or invalid may be based on a level of standards (e.g., 3GPP standards) compliance of the UE and/or the BS.

In some aspects, the single-part payload may include both the measured channel characteristics and the predicted parameters being carried in any suitable combination of fixed code points. For example, the measured channel characteristics and the predicted parameters may be carried by the valid code points of the single-part payload, the measured channel characteristics may be carried by the valid code points while the predicted parameters may be carried by the invalid code points, and/or the measured channel characteristics and the predicted parameters may be carried by the invalid code points of the single-part payload.

In some aspects, the CSI report comprising a single-part payload may include measured parameters such as the SSB-index-RSRP of a set of the strongest SSBRIs (e.g., the four strongest SSBRIs) and the predicted parameters. The predicted parameters may include an indicator indicating the predicted strongest SSBRI will remain the same as the most recent measured strongest SSBRI for a period of time (e.g., 20 ms, 40 ms, 80 ms, or more). The CSI report may include the period of time over which the predicted strongest SSBRI will remain the same as the most recent measured strongest SSBRI. In some aspects, the predicted parameters may include an indicator indicating the predicted strongest SSBRI will change at a future point in time. The future point in time may be relative to the time of the most recently received SSBs. The CSI report may include an indicator indicating when the predicted strongest SSBRI will change, the SSBRI that the strongest SSBRI will change to, a probability associated with the predicted strongest SSBRI, an RSRP associated with the SSBRI that the strongest SSBRI will change to, a predicted mean of the RSRP associated with the SSBRI that the strongest SSBRI will change to, and/or a predicted variance of the RSRP associated with the SSBRI that the strongest SSBRI will change to.

In some aspects, the CSI report may comprise a two-part payload. The two-part payload may include a first part having a fixed payload size and a second part having a payload size based on at least one of the measured channel characteristics included in the first part or the parameters of the predicted channel characteristics included in the first part. In some aspects, the first part may include the measured channel characteristics while the second part includes the predicted parameters. The first part may include an indicator indicating which predicted parameter quantities (e.g., strongest SSBRI(s)/CRI(s), probability, mean, variance, PMI, RI, LI, CQI, etc.) are included in the second part. The first part of the two-part payload may also indicate the size of the second part of the two-part payload. The UE may receive a configuration from the BS via a RRC message indicating the predicted parameter quantities to be included in the second part. The payload size of the second part may be variable and based on the predicted parameter quantities to be included in the second part. In some aspects, the second part may be compressed using a lossless data compression algorithm to reduce the size of the second part payload. In some aspects, the size of the second part payload may be reduced by a differential reporting method where the predicted parameters are reported as a differential to a previous second part CSI report.

In some aspects, the first part may include the measured channel characteristics and a first portion of the predicted parameters while the second part includes a second portion (e.g., a remaining portion) of the predicted parameters. For example, the first part of the two-part payload may include an indicator that the strongest SSBRI will change at a future time while the second part includes the time when the strongest SSBRI will change and/or the RSRP of the predicted strongest SSBRI.

In some aspects, the first part of the CSI report may include an indicator indicating the CSI report comprises only the first part. In this regard, the UE may only transmit the first part of the two-part payload to the BS further reducing overhead and resources. The indicator indicating the CSI report comprises only the first part may indicate to the BS that the strongest SSBRI/CRI will remain the same before the next CSI reporting period. The UE may continue to include only the first part in the CSI report for each reporting period until the UE predicts that the strongest SSBRI/CRI will change.

In some aspects, predetermined code points in the CSI report may indicate the single-part, fixed-payload CSI report includes the predicted parameters. In this regard, the BS may transmit an indicator to the UE via an RRC message indicating the predetermined code points that indicate the CSI report includes the predicted parameters. For example, a set of predetermined L1-RSRP/SINR code points may indicate that the predicted parameter quantities are included in the CSI report. The set of predetermined L1-RSRP/SINR code points may include invalid code points for the strongest SSBRI/CRI's L1-RSRP. As another example, a predetermined code point (e.g., a single bit) in the CSI report may indicate the CSI report includes the predicted parameters.

In some aspect, the UE may indicate an invalid RSRP of a beam in the CSI report to indicate to the BS to reinterpret the single-part, fixed-payload CSI report. For example, the UE may indicate via a predetermined code point and/or an invalid RSRP of a beam to the BS to interpret the quantities in the CSI report as predicted parameters rather than measured parameters. Different predetermined code points may indicate different predicted parameters are included in the CSI report.

Further aspects of the present disclosure include the following:

Aspect 1 includes a method of wireless communication performed by a user equipment (UE), the method comprising receiving, from a base station (BS), a configuration for a channel state information (CSI) report setting, wherein a report quantity configured by the CSI report setting comprises at least measured channel characteristics of channel state information reference signal (CSI-RS) resources or synchronization signal block (SSB) resources for channel measurement associated with the CSI report setting; and parameters of predicted channel characteristics associated with the CSI-RS resources or the SSB resources for channel measurement associated with the CSI report setting; and transmitting, to the BS, a CSI report based on the CSI report setting.

Aspect 2 includes the method of aspect 1 wherein the receiving the configuration for the CSI report setting comprises receiving the configuration for the CSI report setting via a radio resource control (RRC) message.

Aspect 3 includes the method of any of aspects 1-2, wherein the parameters of the predicated channel characteristics associated with the CSI-RS resources or the SSB resources for the channel measurement associated with the CSI report setting comprise at least one of a reference signal received power (RSRP) associated with the CSI-RS resources; a signal-to-noise and interference ratio (SINR) associated with the CSI-RS resources; a RSRP associated with the SSB resources; or a SINR associated with the SSB resources.

Aspect 4 includes the method of any of aspects 1-3, wherein the CSI report comprises an indicator indicating whether a reference signal received power (RSRP) of the predicted channel characteristics is stronger than a RSRP of the measured channel characteristics.

Aspect 5 includes the method of any of aspects 1-4, wherein the CSI report comprises an indicator indicating whether a signal-to-noise and interference ratio (SINR) of the predicted channel characteristics is stronger than a SINR of the measured channel characteristics.

Aspect 6 includes the method of any of aspects 1-5, wherein the CSI report comprises an index associated with the predicted channel characteristics.

Aspect 7 includes the method of any of aspects 1-6, wherein the CSI report comprises an ordering of indexes associated with the predicted channel characteristics.

Aspect 8 includes the method of any of aspects 1-7, wherein the CSI report comprises a RSRP associated with one or more of the predicted channel characteristics.

Aspect 9 includes the method of any of aspects 1-8, wherein the CSI report comprises prediction probabilities associated with one or more of the predicted channel characteristics.

Aspect 10 includes the method of any of aspects 1-9, wherein the CSI report comprises a mean associated with one or more of the predicted channel characteristics.

Aspect 11 includes the method of any of aspects 1-10, wherein the CSI report comprises a variance associated with one or more of the predicted channel characteristics.

Aspect 12 includes the method of any of aspects 1-11, wherein the CSI report comprises a precoding matrix indicator (PMI) associated with one or more of the predicted channel characteristics.

Aspect 13 includes the method of any of aspects 1-12, wherein the CSI report comprises a rank indicator (RI) associated with one or more of the predicted channel characteristics.

Aspect 14 includes the method of any of aspects 1-13, wherein the CSI report comprises a channel quality indicator (CQI) associated with one or more of the predicted channel characteristics.

Aspect 15 includes the method of any of aspects 1-14, wherein the transmitting the CSI report comprises transmitting, to the BS, the CSI report comprising a single-part payload, the single-part payload including the measured channel characteristics and the parameters of the predicted channel characteristics.

Aspect 16 includes the method of any of aspects 1-15, wherein the transmitting the CSI report comprises transmitting, to the BS, the CSI report comprising a two-part payload, wherein the two-part payload includes a first part having a fixed payload size; and a second part having a size based on at least one of the measured channel characteristics included in the first part; or the parameters of the predicted channel characteristics included in the first part.

Aspect 17 includes the method of any of aspects 1-16, wherein the first part of the two-part payload indicates the size of the second part of the two-part payload.

Aspect 18 includes the method of any of aspects 1-17, wherein the first part of the two-part payload includes a first set of the parameters of the predicted channel characteristics and the second part of the two-part payload includes a second set of the parameters of the predicted channel characteristics, the second set being different from the first set.

Aspect 19 includes the method of any of aspects 1-18, wherein the transmitting the CSI report comprises at least one of transmitting the first and second parts of the two-part payload via a physical uplink shared channel (PUSCH); transmitting the first part of the two-part payload via a physical uplink control channel (PUCCH) and transmitting the second part of the two-part payload via the PUSCH; or transmitting the first and second parts of the two-part payload via the PUCCH.

Aspect 20 includes the method of any of aspects 1-19, wherein the transmitting the CSI report comprises transmitting, to the BS, the CSI report comprising a first part, wherein the first part of the CSI report includes an indicator indicating the CSI report comprises only the first part.

Aspect 21 includes the method of any of aspects 1-20, further comprising transmitting, to the BS, a capability message indicating the UE supports prediction based beam management.

Aspect 22 includes the method of any of aspects 1-21, wherein the transmitting the CSI report based on the CSI report setting comprises transmitting the CSI report on at least one of a periodic basis or a semi-persistent basis.

Aspect 23 includes the method of any of aspects 1-22, wherein the predicted channel characteristics are associated with a time instance later than a time instance associated with the measured channel characteristics.

Aspect 24 includes the method of any of aspects 1-23, wherein the transmitting the CSI report comprises transmitting, to the BS, the CSI report comprising an indicator indicating the CSI report comprises the parameters of the predicted channel characteristics, wherein the indicator comprises at least one of an invalid code point for reporting a reference signal received power (RSRP) associated with the CSI-RS resources; an invalid code point for reporting a signal-to-noise and interference ratio (SINR) associated with the CSI-RS resources; an invalid code point for reporting a RSRP associated with the SSB resources; or an invalid code point for reporting a SINR associated with the SSB resources.

Aspect 25 includes the method of any of aspects 1-24, wherein the transmitting the CSI report comprises transmitting, to the BS, the CSI report comprising a code point indicating the CSI report comprises the parameters of the predicted channel characteristics.

Aspect 26 includes a method of wireless communication comprising transmitting a configuration for a channel state information (CSI) report setting, wherein a report quantity configured by the CSI report setting comprises at least measured channel characteristics of channel state information reference signal (CSI-RS) resources or synchronization signal block (SSB) resources for channel measurement associated with the CSI report setting; and parameters of predicted channel characteristics associated with the CSI-RS resources or the SSB resources for channel measurement associated with the CSI report setting; and receiving a CSI report based on the CSI report setting.

Aspect 27 includes the method of aspect 26, wherein the receiving the CSI report comprises receiving the CSI report comprising a single-part payload, the single-part payload including the measured channel characteristics and the parameters of the predicted channel characteristics.

Aspect 28 includes the method of any of aspects 26 or 27, wherein the receiving the CSI report comprises receiving the CSI report comprising a two-part payload, wherein the two-part payload includes a first part having a fixed payload size; and a second part having a size based on at least one of the measured channel characteristics included in the first part; or the parameters of the predicted channel characteristics included in the first part.

Aspect 29 includes method of any of aspects 26-28, wherein the receiving the CSI report comprises receiving the CSI report comprising a first part, wherein the first part of the CSI report includes an indicator indicating the CSI report comprises only the first part.

Aspect 30 includes a non-transitory computer-readable medium storing one or more instructions for wireless communication, the one or more instructions comprising one or more instructions that, when executed by one or more processors of a user equipment (UE), cause the UE to perform any one of aspects 1-25.

Aspect 31 includes a non-transitory computer-readable medium storing one or more instructions for wireless communication, the one or more instructions comprising one or more instructions that, when executed by one or more processors of an apparatus for wireless communications, cause the apparatus to perform any one of aspects 26-29.

Aspect 32 includes a user equipment (UE) comprising one or more means to perform any one or more of aspects 1-25.

Aspect 33 includes an apparatus for wireless communications comprising one or more means to perform any one or more of aspects 26-29.

Aspect 34 includes a user equipment (UE) comprising a memory, a transceiver and at least one processor coupled to the memory and the transceiver, wherein the wireless node is configured to perform any one or more of aspects 1-25.

Aspect 35 includes an apparatus for wireless communications comprising a memory, a transceiver and at least one processor coupled to the memory and the transceiver, wherein the apparatus is configured to perform any one or more of aspects 26-29.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of [at least one of A, B, or C] means A or B or C or AB or AC or BC or ABC (i.e., A and B and C).

As those of some skill in this art will by now appreciate and depending on the particular application at hand, many modifications, substitutions and variations can be made in and to the materials, apparatus, configurations and methods of use of the devices of the present disclosure without departing from the spirit and scope thereof. In light of this, the scope of the present disclosure should not be limited to that of the particular instances illustrated and described herein, as they are merely by way of some examples thereof, but rather, should be fully commensurate with that of the claims appended hereafter and their functional equivalents.

1. A method of wireless communication performed by a user equipment (UE), the method comprising:
receiving, from a base station (BS), a configuration for a channel state information (CSI) report setting, wherein a report quantity configured by the CSI report setting comprises at least:
measured channel characteristics of channel state information reference signal (CSI-RS) resources or synchronization signal block (SSB) resources for channel measurement associated with the CSI report setting; and
parameters of predicted channel characteristics associated with the CSI-RS resources or the SSB resources for channel measurement associated with the CSI report setting; and
transmitting, to the BS, a CSI report based on the CSI report setting.

2. The method of claim 1, wherein the receiving the configuration for the CSI report setting comprises receiving the configuration for the CSI report setting via a radio resource control (RRC) message.

3. The method of claim 1, wherein:
the parameters of the predicated channel characteristics associated with the CSI-RS resources or the SSB resources for the channel measurement associated with the CSI report setting comprise at least one of:
a reference signal received power (RSRP) associated with the CSI-RS resources;
a signal-to-noise and interference ratio (SINR) associated with the CSI-RS resources;
a RSRP associated with the SSB resources; or
a SINR associated with the SSB resources.

4. The method of claim 1, wherein the CSI report comprises at least one of:
an indicator indicating whether a reference signal received power (RSRP) of the predicted channel characteristics is stronger than a RSRP of the measured channel characteristics;
an indicator indicating whether a signal-to-noise and interference ratio (SINR) of the predicted channel characteristics is stronger than a SINR of the measured channel characteristics;
an index associated with the predicted channel characteristics;
an ordering of indexes associated with the predicted channel characteristics;
a RSRP associated with one or more of the predicted channel characteristics;
prediction probabilities associated with one or more of the predicted channel characteristics;
a mean associated with one or more of the predicted channel characteristics;
a variance associated with one or more of the predicted channel characteristics;
a precoding matrix indicator (PMI) associated with one or more of the predicted channel characteristics;
a rank indicator (RI) associated with one or more of the predicted channel characteristics;
a layer indicator (LI) associated with one or more of the predicted channel characteristics; or
channel quality information (CQI) associated with one or more of the predicted channel characteristics.

5. The method of claim 1, wherein the transmitting the CSI report comprises:
transmitting, to the BS, the CSI report comprising a single-part payload, the single-part payload including the measured channel characteristics and the parameters of the predicted channel characteristics.

6. The method of claim 1, wherein the transmitting the CSI report comprises:
transmitting, to the BS, the CSI report comprising a two-part payload, wherein the two-part payload includes:
a first part having a fixed payload size; and
a second part having a size based on at least one of:
the measured channel characteristics included in the first part; or
the parameters of the predicted channel characteristics included in the first part.

7. The method of claim 6, wherein the first part of the two-part payload indicates the size of the second part of the two-part payload.

8. The method of claim 6, wherein the first part of the two-part payload includes a first set of the parameters of the predicted channel characteristics and the second part of the two-part payload includes a second set of the parameters of the predicted channel characteristics, the second set being different from the first set.

9. The method of claim 6, wherein the transmitting the CSI report comprises at least one of:
transmitting the first and second parts of the two-part payload via a physical uplink shared channel (PUSCH);
transmitting the first part of the two-part payload via a physical uplink control channel (PUCCH) and transmitting the second part of the two-part payload via the PUSCH; or
transmitting the first and second parts of the two-part payload via the PUCCH.

10. The method of claim 1, wherein the transmitting the CSI report comprises:
transmitting, to the BS, the CSI report comprising a first part, wherein the first part of the CSI report includes an indicator indicating the CSI report comprises only the first part.

11. The method of claim 1, further comprising:
transmitting, to the BS, a capability message indicating the UE supports prediction based beam management.

12. The method of claim 1, wherein the transmitting the CSI report based on the CSI report setting comprises transmitting the CSI report on at least one of a periodic basis or a semi-persistent basis.

13. The method of claim 1, wherein the predicted channel characteristics are associated with a time instance later than a time instance associated with the measured channel characteristics.

14. The method of claim 1, wherein the transmitting the CSI report comprises:
transmitting, to the BS, the CSI report comprising an indicator indicating the CSI report comprises the parameters of the predicted channel characteristics, wherein the indicator comprises at least one of:
an invalid code point for reporting a reference signal received power (RSRP) associated with the CSI-RS resources;
an invalid code point for reporting a signal-to-noise and interference ratio (SINR) associated with the CSI-RS resources;
an invalid code point for reporting a RSRP associated with the SSB resources; or
an invalid code point for reporting a SINR associated with the SSB resources.

15. The method of claim 1, wherein the transmitting the CSI report comprises:
transmitting, to the BS, the CSI report comprising a code point indicating the CSI report comprises the parameters of the predicted channel characteristics.

16. A method of wireless communication, comprising:
transmitting a configuration for a channel state information (CSI) report setting, wherein a report quantity configured by the CSI report setting comprises at least:
measured channel characteristics of channel state information reference signal (CSI-RS) resources or synchronization signal block (SSB) resources for channel measurement associated with the CSI report setting; and
parameters of predicted channel characteristics associated with the CSI-RS resources or the SSB resources for channel measurement associated with the CSI report setting; and
receiving a CSI report based on the CSI report setting.

17. The method of claim 16, wherein the receiving the CSI report comprises:
receiving the CSI report comprising a single-part payload, the single-part payload including the measured channel characteristics and the parameters of the predicted channel characteristics.

18. The method of claim 16, wherein the receiving the CSI report comprises:
receiving the CSI report comprising a two-part payload, wherein the two-part payload includes:
a first part having a fixed payload size; and
a second part having a size based on at least one of:
the measured channel characteristics included in the first part; or
the parameters of the predicted channel characteristics included in the first part.

19. The method of claim 16, wherein the receiving the CSI report comprises:
receiving the CSI report comprising a first part, wherein the first part of the CSI report includes an indicator indicating the CSI report comprises only the first part.

20. A user equipment (UE) comprising:
a memory;
a transceiver; and
at least one processor coupled to the memory and the transceiver, wherein the UE is configured to:
receive, from a base station (BS), a configuration for a channel state information (CSI) report setting, wherein a report quantity configured by the CSI report setting comprises at least:
measured channel characteristics of channel state information reference signal (CSI-RS) resources or synchronization signal block (SSB) resources for channel measurement associated with the CSI report setting; and
parameters of predicted channel characteristics associated with the CSI-RS resources or the SSB resources for channel measurement associated with the CSI report setting; and
transmit, to the BS, a CSI report based on the CSI report setting.

21. The UE of claim 20, wherein the UE is further configured to:
receive the configuration for the CSI report setting via a radio resource control (RRC) message.

22. The UE of claim 20, wherein:
the parameters of the predicated channel characteristics associated with the CSI-RS resources or the SSB resources for the channel measurement associated with the CSI report setting comprise at least one of:
a reference signal received power (RSRP) associated with the CSI-RS resources;
a signal-to-noise and interference ratio (SINR) associated with the CSI-RS resources;
a RSRP associated with the SSB resources; or
a SINR associated with the SSB resources.

23. The UE of claim 20, wherein the CSI report comprises at least one of:
an indicator indicating whether a reference signal received power (RSRP) of the predicted channel characteristics is stronger than a RSRP of the measured channel characteristics;
an indicator indicating whether a signal-to-noise and interference ratio (SINR) of the predicted channel characteristics is stronger than a SINR of the measured channel characteristics;
an index associated with the predicted channel characteristics;
an ordering of indexes associated with the predicted channel characteristics;
a RSRP associated with one or more of the predicted channel characteristics;
prediction probabilities associated with one or more of the predicted channel characteristics;
a mean associated with one or more of the predicted channel characteristics;
a variance associated with one or more of the predicted channel characteristics;
a precoding matrix indicator (PMI) associated with one or more of the predicted channel characteristics;
a rank indicator (RI) associated with one or more of the predicted channel characteristics;
a layer indicator (LI) associated with one or more of the predicted channel characteristics; or
channel quality information (CQI) associated with one or more of the predicted channel characteristics.

24. The UE of claim 20, wherein the UE is further configured to:
transmit, to the BS, the CSI report comprising a single-part payload, the single-part payload including the measured channel characteristics and the parameters of the predicted channel characteristics.

25. The UE of claim 20, wherein the UE is further configured to:
transmit, to the BS, the CSI report comprising a two-part payload, wherein the two-part payload includes:
a first part having a fixed payload size; and
a second part having a size based on at least one of:
the measured channel characteristics included in the first part; or
the parameters of the predicted channel characteristics included in the first part.

26. The UE of claim 20, wherein the UE is further configured to:
transmit, to the BS, the CSI report comprising a first part, wherein the first part of the CSI report includes an indicator indicating the CSI report comprises only the first part.

27. The UE of claim 20, wherein the UE is further configured to:
transmit, to the BS, a capability message indicating the UE supports prediction based beam management.

28. The UE of claim 20, wherein the UE is further configured to:
transmit the CSI report on at least one of a periodic basis or a semi-persistent basis.

29. The UE of claim 20, wherein the predicted channel characteristics are associated with a time instance later than a time instance associated with the measured channel characteristics.

30. An apparatus for wireless communications comprising:
a processor;
memory coupled with the processor; and
instructions stored in the memory and executable by the processor to cause the apparatus to:
transmit a configuration for a channel state information (CSI) report setting, wherein a report quantity configured by the CSI report setting comprises at least:
measured channel characteristics of channel state information reference signal (CSI-RS) resources or synchronization signal block (SSB) resources for channel measurement associated with the CSI report setting; and
parameters of predicted channel characteristics associated with the CSI-RS resources or the SSB resources for channel measurement associated with the CSI report setting; and
receive a CSI report based on the CSI report setting.
